(19) United States
(12) Patent Application Publication
(10) Pub. No.: US 2025/0386827 A1
(43) Pub. Date: Dec. 25, 2025

(54) PESTICIDES WITH METAL NANOPARTICLE AND CELLULOSIC NANOMATERIAL COMPLEX

(71) Applicant: NDSU Research Foundation, Fargo, ND (US)

(72) Inventors: Mohiuddin Quadir, West Fargo, ND (US); Long Jiang, Fargo, ND (US); Zhaohui Liu, Fargo, ND (US); Raj Hazra, Fargo, ND (US)

(21) Appl. No.: 19/247,595

(22) Filed: Jun. 24, 2025

Related U.S. Application Data
(60) Provisional application No. 63/663,236, filed on Jun. 24, 2024.

(51) Int. Cl. A01N 59/20; A01N 25/26; A01P 1/00

(52) U.S. Cl. CPC A01N 59/20; A01N 25/26; A01P 1/00

(57) ABSTRACT

Pesticides useful in the treatment of plant disease are provided. A pesticide includes: a nanocellulose scaffold with a cellulose nanocrystal (CNC) that is modified to include a diamine or quaternary amine; and a metal nanoparticle conjugated to the nanocellulose scaffold via the diamine or quaternary amine. Conjugation of the metal nanoparticle to the nanocellulose scaffold can facilitate improved surface adhesion of the metal nanoparticle on a plant surface, thus rendering the metal nanoparticle less amenable to removal from the plant by environmental factors. The enhanced surface adhesion can extend the duration of the antibacterial, antifungal, and/or antiviral action of the metal nanoparticle and reduce the number and/or frequency of pesticide applications required for plant treatment. The pesticide can include a plurality of modified CNCs and metal nanoparticles conjugated to the modified CNCs. Methods for treating plant disease and methods for synthesizing a pesticide are also provided.

### CROSS-REFERENCE TO RELATED APPLICATION

The present application claims priority to U.S. Patent Application Ser. No. 63/663,236 filed on Jun. 24, 2024, the entire disclosure of which is incorporated herein by reference.

### TECHNICAL FIELD

The presently disclosed subject matter generally relates to pesticides. In particular, certain embodiments of the presently disclosed subject matter relate to pesticides that make use of metal nanoparticles and modified cellulosic nanomaterial to promote plant surface adhesion and extend the duration of action.

### BACKGROUND

Bacterial leaf streak (BLS) disease of grain crops is one of the most devastating diseases on grain products worldwide. It has been found to affect most countries in North America, South America, Asia, Africa, Europe, and Australia. In the United States, BLS has been located in every state where wheat is grown. In cases of severe infection, BLS can reduce crop yield by 10% to 60% due to decreases in kernel weight and the number of kernels per spike. In some cases, complete crop yield loss can occur due to the development of sterile spikes.

The bacterial origin of BLS disease has been attributed to Xanthomonas translucens. The translucens group of this bacteria has three entities: cerealis, translucens, and undulosa. Pathovar (pv.) cerealis can infect barley, wheat, oat, and bromegrass, pv. translucens can infect barley, and pv. undulosa can infect barley and wheat. The application of bactericides, fungicides, or biopesticides throughout all stages of bacterial infection can reduce the risk of BLS. In this regard, chemical formulations comprising metal nanoparticles as bactericides for Xanthomonas translucens bacterial infections have been developed. However, as such nanoparticles tend to aggregate due to the attraction between the nanoparticles through the van der Waals interaction, they can be easily removed from plant surfaces by wind, rain, hail, or other natural effects. The washed nanoparticles can pollute soil and groundwater. Stabilizers can be utilized to stabilize nanoparticles and prevent agglomeration. Fossil/synthetic polymer-based stabilizers are widely used in synthesizing antibacterial or antifungal formulations, generating a large amount of microplastic pollution in soil. A total of 14% of global pollution to the freshwater and marine environment is caused by agrochemical-related pollution. These harmful chemicals contaminate underground water in farmlands and cause substantial human health risks. Furthermore, these agrochemicals must be applied multiple times as natural processes (such as rain, wind, and hail) can remove them from plants to soil.

Of course, there are also various other bacterial diseases which can readily and significantly disrupt grain production, such as Corn Goss's wilt, and the use of pesticides, including metal nanoparticles, for such diseases can face the same problems and create the same environmental issues as noted above.

Accordingly, there remains a need in the art for environmentally friendly pesticides that provide longer durations of action and require fewer applications.

### SUMMARY

The presently disclosed subject matter meets some or all of the above-identified needs, as will become evident to those of ordinary skill in the art after a study of the information provided in this document.

This summary describes several embodiments and implementations of the presently disclosed subject matter, and in many cases lists variations and permutations of these embodiments and implementations. This summary is merely exemplary of the numerous and varied embodiments and implementations. Mention of one or more representative features of a given embodiment or implementation is likewise exemplary. Such an embodiment or implementation can typically exist with or without the feature(s) mentioned; likewise, those features can be applied to other embodiments and implementations of the presently disclosed subject matter, whether listed in this summary or not. To avoid excessive repetition, this summary does not list or suggest all possible combinations of such features.

The present disclosure includes pesticides which can be used to treat plant disease, and which make use of metal nanoparticles and modified cellulose nanomaterial to promote plant surface adhesion and extend the duration antibacterial, antifungal, and/or antiviral action of the metal nanoparticles.

An exemplary pesticide includes: a nanocellulose scaffold including a cellulose nanocrystal (CNC) modified to include a diamine or quaternary amine; and a metal nanoparticle conjugated to the nanocellulose scaffold via the diamine or the quaternary amine. In some embodiments, the metal nanoparticle is a copper nanoparticle conjugated to the diamine of the CNC. In some embodiments, the CNC includes a hydroxyl group that is substituted with trimethylethylene diamine (TMEDA). In some embodiments, the copper nanoparticle is conjugated to TMEDA. In some embodiments, the metal nanoparticle is a silver nanoparticle conjugated to and stabilized by the quaternary amine of the CNC. In some embodiments, the CNC includes a hydroxyl group that is substituted with a quaternary ammonium compound that includes a quaternary amine. In some embodiments, the silver nanoparticle is conjugated to and stabilized by the quaternary ammonium compound.

In some embodiments, the nanocellulose scaffold includes a plurality of CNCs that are modified to include diamines or quaternary amines, and the pesticide includes a plurality of metal nanoparticles conjugated to the nanocellulose scaffold via the diamines or the quaternary amines of the plurality of CNCs. In some embodiments, each CNC of the nanocellulose scaffold is bound or attracted to at least one other CNC of the plurality of CNCs.

The pesticides of the present disclosure can be utilized for the treatment of plant disease. Accordingly, methods for treating plant disease in which an effective amount of a pesticide of the present disclosure is administered to a plant in need thereof are also provided herein. In some implementations, the pesticide is administered to treat bacterial leaf streak disease. In some implementations, the plant is infected with Xanthomonas translucens bacteria. In some implementations, the plant is a wheat plant.

Methods for synthesizing a pesticide are also provided herein. An exemplary method for synthesizing a pesticide includes: (a) modifying one or more CNCs to include a diamine or quaternary amine; and (b) conjugating one or more metal nanoparticles to the one or more CNCs via the diamine or the quaternary amine of the one or more CNCs.

In some implementations, modifying the one or more CNCs includes substituting a hydroxyl group of the one or more CNCs with a tosyl group to form one or more Tos-CNCs, and then substituting the tosyl group of the one or more Tos-CNCs with a diamine. In some implementations, the hydroxyl group of the one or more CNCs are substituted with the tosyl group via tosylation. In some implementations pyridine and p-toluenesulfonyl chloride is used to facilitate tosylation. In some implementations, the tosyl group of the one or more Tos-CNCs are substituted with TMEDA.

In some implementations, modifying the one or more CNCs includes substituting a hydroxyl group of the one or more CNCs with a quaternary ammonium compound. In some implementations, the hydroxyl group of the one or more CNCs is substituted with the quaternary ammonium compound by mixing the one or more CNCs with glycidyltrimethylammonium chloride (GTMAC). In some implementations, modifying the one or more CNCs includes dispersing the one or more CNCs and NaOH in a solvent including dimethyl sulfoxide (DMSO) prior to mixing the one or more CNCs with GTMAC.

In some implementations, conjugating the one or more metal nanoparticles includes conjugating one or more copper nanoparticles to the diamine of the one or more modified CNCs. In some implementations, conjugating the one or more metal nanoparticles includes conjugating one or more silver nanoparticles to the quaternary amine of the one or more modified CNCs.

### BRIEF DESCRIPTION OF THE DRAWINGS

The features of the invention are set forth with particularity in the appended claims. A better understanding of the features and advantages of the present invention will be obtained by reference to the following detailed description that sets forth illustrative embodiments, in which the principles of the invention are used, and the accompanying drawings of which:

FIG. 1 is a schematic diagram showing the spraying of copper nanoparticle complexed trimethylethylene diamine-cellulose nanocrystal (Cu-TMEDA-CNC) on plant leaves for antibacterial protection by releasing copper ions.

FIG. 2 is a schematic diagram showing a reaction scheme from CNC to cationized CNC (CNC-Cat) and silver nanoparticle (Ag NP) stabilization by CNC-Cat through charge exchange. Ag NP decorated CNC (CNC-Cat-Ag NP) adheres to the plant leaf and releases Ag⁺, which inhibits bacterial infections.

FIG. 3 is a reaction scheme showing tosylation of CNCs (Tos-CNCs) in pyridine.

FIG. 4 is a reaction scheme showing the TMEDA reaction with CNCs (TMEDA-CNCs) in diethylformamide (DMF) at high temperatures in a high-pressure tube.

FIG. 5 is a graph showing Fourier Transform Infrared (FTIR) spectra of pristine CNCs and freeze-dried Tos-CNCs and TMEDA-CNCs powder.

FIG. 6A is a graph showing X-ray photoelectron spectroscopy (XPS) spectra of pristine CNCs and Tos-CNCs.

FIG. 6B is a graph showing high-resolution spectra of pristine CNCs and Tos-CNCs in the region of 170 ev.

FIG. 6C is a graph showing XPS spectra of Tos-CNCs and TMEDA-CNCs.

FIG. 6D is a graph showing high-resolution spectra of Tos-CNCs and TMEDA-CNCs in the region of 404 eV.

FIG. 7 is a graph showing zeta potential of CNC-Cat synthesized under variable solvent ratios. The solvent system used for CNC-Cat 1=glycidyl trimethylammonium chloride (GTMAC) and de-ionized (DI) water (2:1 ratio); CNC-Cat 2=GTMAC and DI water (1:1 ratio); CNC-Cat 3=GTMAC and DI water (1:1.5 ratio); CNC-Cat 4=GTMAC, DI water, and dimethylsulfoxide (DMSO) (1:0.9:0.1 ratio); CNC-Cat 5=GTMAC, DI water, and DMSO (1:0.8:0.2 ratio); CNC-Cat 6=GTMAC, DI water, and DMSO (1:0.5:0.5 ratio); Paired sample t-test with respect to pristine CNC, ns for P>0.05, * for P≤0.05, ** for P≤0.01 and *** for P≤0.001.

FIG. 8 is a graph showing the nitrogen/carbon (N/C) ratio measured from the combustion process on a dried powder sample of CNC-Cat synthesized under variable solvent ratios. The solvent system used for CNC-Cat 1=GTMAC and DI water (2:1 ratio); CNC-Cat 2=GTMAC and DI water (1:1); CNC-Cat 3=GTMAC and DI water (1:1.5); CNC-Cat 4=GTMAC, DI water, and DMSO (1:0.9:0.1); CNC-Cat 5=GTMAC, DI water, and DMSO (1:0.8:0.2); CNC-Cat 6=GTMAC, DI water, and DMSO (1:0.5:0.5).

FIG. 9 is a graph showing FTIR analysis of pristine CNC powder and freeze dried CNC-Cat powder.

FIG. 10 is a graph showing XPS analysis of pristine CNC powder and freeze dried cationized CNC (CNC-Cat) powder (the inset graph shows a high magnification CNC-Cat spectrum).

FIG. 11A is a graph showing ultraviolet-visible (UV-Vis) spectra of Cu-TMEDA-CNCs solution samples at different Cu to TMEDA-CNCs ratios.

FIG. 11B is a graph showing spectrophotometric titration plot of the UV-Vis absorbance at 600 nm when complexing an increasing amount of CuSO₄ with a constant amount of TMEDA-CNCs.

FIG. 11C is a graph showing XPS spectra of TMEDA-CNCs and Cu-TMEDA-CNCs.

FIG. 11D is a graph showing high resolution spectra in the region of the Cu (2p) peak of TMEDA-CNCs and Cu-TMEDA-CNCs.

FIG. 12A is a transmission electron microscopy (TEM) image showing pristine CNC.

FIG. 12B is a TEM image of Cu-TMEDA-CNC complex.

FIG. 13A is a graph showing UV-Vis spectrum of CNC-Cat-Ag NP dispersed in water (inset image for calibration curve with known concentration of water dispersed Ag NPs).

FIG. 13B is a graph showing a spectrophotometric titration plot to evaluate the volume ratio of AgNO₃ (100 mM) and NaBH₄ (10 mM) required for formation of Ag NPs (Absorbance at 400 nm was selected for the evaluation); Paired sample t-test with respect to AgNO₃:NaBH₄ ratio of 0.25 volumetric ratio, ns for P>0.05, * for P≤0.05, ** for P≤0.01 and *** for P≤0.001.

FIG. 14A is a graph showing XPS analysis on CNC-Cat and CNC-Cat stabilized Ag NP (CNC-Cat-Ag NP) powder (high magnification scan sweep is shown in the inset).

FIG. 14B is a graph showing XPS analysis on Ag NP and stabilized CNC-Cat-Ag NP.

FIG. 15A is a TEM image of nanoparticle suspension of pristine CNC.

FIG. 15B is a TEM image of nanoparticle suspension of CNC-Cat stabilized Ag NPs at a low magnification.

FIG. 15C is a TEM image of nanoparticle suspension of CNC-Cat stabilized Ag NPs at a first high magnification.

FIG. 15D is a TEM image of nanoparticle suspension of CNC-Cat stabilized Ag NPs at a second high magnification.

FIG. 16A is a graph showing contact angle, surface tension, adhesion tension, and solid-liquid adhesion energy were evaluated on wheat leaf surface using droplets with variable concentrations of TMEDA-CNCs.

FIG. 16B is a graph showing contact angle, surface tension, adhesion tension, and solid-liquid adhesion energy were evaluated on wheat leaf surface using droplets with variable concentrations of CuSO₄.

FIG. 17A is a graph showing the angle difference between the advancing and receding contact angles measured at 0°, 45°, 60°, and 90° leaf tilt angle for solutions with different TMEDA-CNC concentrations.

FIG. 17B is a graph showing the angle difference between the advancing and receding contact angles measured at 0°, 45°, 60°, and 90° leaf tilt angle for solutions with different CuSO₄ concentrations.

FIG. 18A is a scanning electron microscopy (SEM) image of Cu-TMEDA-CNC coated wheat leaf surface at ×150 magnification (at 15 kV).

FIG. 18B is a SEM image of Cu-TMEDA-CNC coated wheat leaf surface at ×1000 magnification (at 15 kV).

FIG. 18C is a SEM image of Cu-TMEDA-CNC coated wheat leaf surface at ×3000 magnification (at 15 kV).

FIG. 18D is a field emission scanning electron microscope (FESEM) image of Cu-TMEDA-CNC coated wheat leaf surface at ×15,000 magnification (at 5 kV).

FIG. 19A is a graph showing contact angle, surface tension, adhesion tension and solid-liquid adhesion energy for CNC-Cat water suspensions on the wheat leaf surface with different concentrations of CNC-Cat.

FIG. 19B is a graph showing contact angle, surface tension, adhesion tension and solid-liquid adhesion energy for CNC-Cat water suspensions on the wheat leaf surface with different concentrations of CNC-Cat.

FIG. 20A is a graph showing the difference between the advancing and receding contact angles for CNC-Cat water suspensions measured by tilting wheat plant leaf at 0°, 45°, 60°, and 90° angles with respect to the ground.

FIG. 20B is a graph showing the angel difference between the advancing and receding contact angles for Ag NP water suspensions measured by tilting wheat plant leaf at 0°, 45°, 60°, and 90° angles with respect to the ground.

FIG. 21A is a SEM image showing wheat plant leaf surface alone at ×500 magnification (at 15 kV).

FIG. 21B is a SEM image showing CNC-Cat-Ag NPs sprayed wheat plant leaf surface at ×500 magnification (at 15 kV).

FIG. 21C is a SEM image showing CNC-Cat-Ag NPs sprayed wheat plant leaf surface at ×1000 magnification (at 15 kV).

FIG. 21D is a FESEM image of CNC-Cat-Ag NPs sprayed wheat plant leaf surface at ×30,000 magnification (at 5 kV).

FIG. 22 is a graph showing the antibacterial performance on Xanthomonas translucens pv. undulosa of Cu-TMEDA-CNCs and CuSO4 solution; Paired sample t-test with respect to CuSO₄ concentration of 10 mg/mL, ns for P>0.05, * for P<0.05, ** for P<0.01 and *** for P<0.001.

FIG. 23A is a graph showing an antibacterial study on Xanthomonas translucens pv. undulosa with commercially available Ag NPs; Paired sample t-test with respect to Ag NPs concentration of 1 mg/mL, ns for P>0.05, * for P<0.05, ** for P<0.01 and *** for P<0.001.

FIG. 23B is a graph showing an antibacterial study on Xanthomonas translucens pv. undulosa with CNC-Cat-Ag NPs; Paired sample t-test with respect to Ag NPs concentration of 1 mg/mL, ns for P>0.05, * for P<0.05, ** for P<0.01 and *** for P<0.001.

FIG. 24A is an image showing the visual effects of streak disease on unwashed wheat plant leaves after being treated with water, CNC-Cat Ag NPs, and control (mixture of pristine CNC and commercially available Ag NP).

FIG. 24B is an image showing the visual effects of streak disease on washed wheat plant leaves after being treated with water, CNC-Cat Ag NPs, and control (mixture of pristine CNC and commercially available Ag NP).

FIG. 25A is a graph showing the percentage of bacterial streak disease on unwashed and washed wheat plant leaves after treated with water, CNC-Cat-Ag NPs (approximate 2.0 mg/mL) and control (mixture of pristine CNC and commercially available Ag NPs) followed by disease inoculation; Paired sample t-test, ns for P>0.05, * for P≤0.05, ** for P≤0.01 and * for P≤0.001.

FIG. 25B is a graph showing the disease score calculated on unwashed and washed wheat plant leaves after treated with water, CNC-Cat-Ag NPs (approximate 2.0 mg/mL) and control (mixture of pristine CNC and commercially available Ag NPs) followed by disease inoculation; Paired sample t-test, ns for P>0.05, * for P≤0.05, ** for P≤0.01 and *** for P<0.001.

FIG. 26 is a graph showing the percentage of bacterial streak disease calculated on unwashed and washed wheat plant leaves after being treated with CNC-TMEDA-Cu nanoparticles, control solution (mixture of pristine CNC and commercially available CuSO₄), and water. Paired sample t-test, ns for P>0.05, * for P≤0.05, ** for P≤0.01 and *** for P<0.001.

### DESCRIPTION OF EXEMPLARY EMBODIMENTS

The details of one or more embodiments of the presently disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

The present disclosure is based, in part, on the discovery that complexing certain metal nanoparticles (NPs) with a cellulose nanomaterial facilitates improved surface adhesion of the metal nanoparticles to plant surfaces, thus rendering the metal nanoparticles less amenable to removal from the plant surface by wind, rain, hail, or other environmental factors. As a result, the metal nanoparticles, which can act as a bactericide, fungicide, or viricide, remain in association or contact with the plant surface for longer durations without diminished anti-bacterial, anti-fungal, or anti-viral effect, thereby reducing the number and/or frequency of pesticide applications required to treat the plant for disease and minimize soil pollution.

Accordingly, in one aspect, the present disclosure includes pesticides that can be utilized to treat plant disease.

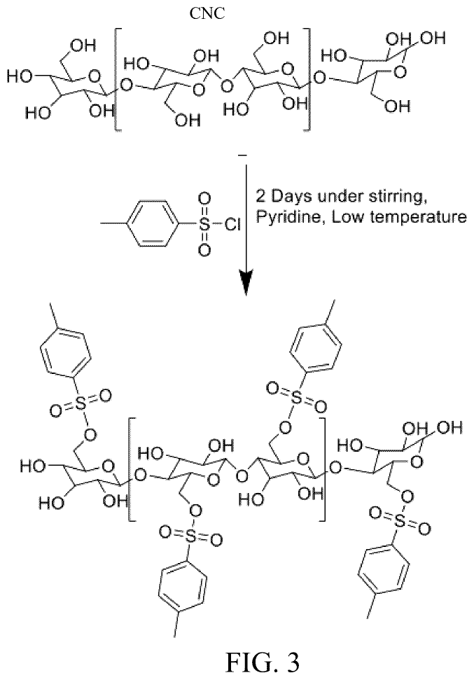

An exemplary pesticide made in accordance with the present disclosure includes: a nanocellulose scaffold; and one or more metal nanoparticles conjugated to the nanocellulose scaffold. In some embodiments, the nanocellulose scaffold is comprised of one or more cellulose nanocrystals (CNCs). CNCs are the crystalline form of cellulose and comprised of repeating units of β-D-glucopyranose linked by β(1→4) glycosidic bonds, with each glucose monomer containing hydroxyl (—OH) groups, as shown in FIGS. 2-3. The abundant hydroxyl groups can be leveraged through chemical modification to provide functional groups to which the metal nanoparticles can be conjugated to provide for increased stabilization of the metal nanoparticles when the pesticide is applied to plant surfaces, as compared to, for example, either the application of the metal nanoparticles alone or the metal nanoparticles simply mixed with CNCs. In this regard, one or more hydroxyl groups of the CNCs making up the nanocellulose scaffold can be substituted to provide a functional group to which a metal nanoparticle can bind to thereby conjugate the metal nanoparticle to the nanocellulose scaffold. In various embodiments, the pesticide can include a single CNC with a plurality of its hydroxyl groups substituted or include multiple CNCs with a plurality of their hydroxyl groups substituted. In other words, in various embodiments, the respective CNCs of the nanocellulose scaffold can include single or multiple hydroxyl group substitutions consistent with those disclosed herein.

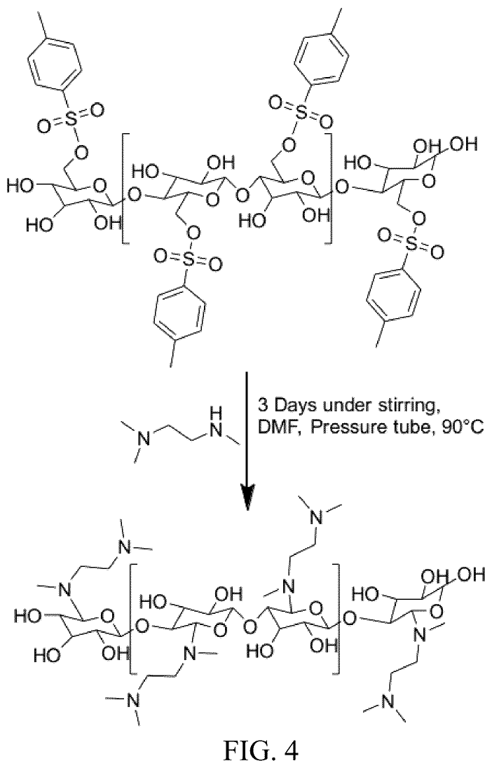

In various embodiments, the CNCs of the nanocellulose scaffold are chemically modified to include one or more diamines, one or more quaternary amines, or a combination thereof to which the metal nanoparticles can bind to. In some embodiments, the CNCs of the nanocellulose scaffold are modified as to substitute one or more hydroxyl groups thereof with a diamine. In some embodiments, the CNCs are modified as to substitute one or more hydroxyl groups thereof with trimethylethylene diamine (TMEDA), as further discussed below, to provide a diamine to which a metal nanoparticle of the pesticide can bind (FIGS. 3-4). A CNC modified in such manner can thus be characterized or identified as a “TMEDA-CNC” or a “CNC-TMEDA”. In some embodiments, the CNCs are modified as to substitute one or more hydroxyl groups thereof with a quaternary ammonium compound, as further discussed below, that includes a quaternary amine to which a nanoparticle of the pesticide can bind (FIG. 2). CNCs modified through such substitution are thus cationized. As such, a CNC modified in such manner can be characterized or identified as a “CNC-Cat” or a “Cat-CNC.” Of course, the manner in which a metal nanoparticle binds to a substituted hydroxyl group of a CNC will vary depending on the nature of the substitution and the metal nanoparticle utilized. In various embodiments, a metal nanoparticle of the pesticide may bind to a substituted hydroxyl group of a CNC via covalent or ionic bonding.

It has been discovered that both copper nanoparticles and silver nanoparticles can be complexed with modified CNCs consistent with those described above to provide pesticides that are effective with respect to treating plant disease, such as bacterial leaf streak (BLS). Accordingly, in some embodiments, the one or more metal nanoparticles of the pesticide includes one or more copper nanoparticles. In some embodiments, the one or more copper nanoparticles of the pesticide are conjugated to the nanocellulose scaffold via conjugation to the diamine(s) of the modified CNC(s). In some embodiments, the one or more metal nanoparticles of the pesticide includes one or more silver nanoparticles. In some embodiments, the one or more silver nanoparticle of the pesticide are conjugated to the nanocellulose scaffold via conjugation to the quaternary amine(s) of the quaternary ammonium compound(s) of the modified CNC(s). In some embodiments, alternative metal nanoparticles may be complexed with the nanocellulose scaffold. In this regard, it has been found that metals such as platinum (Pt), ruthenium (Ru), palladium (Pd), iridium (Ir), nickel (Ni), gold (Au), yttrium (Y), lanthanum (La), neodymium (Nd) can also be conjugated diamine groups. It has also been found that metals including copper (Cu), manganese (Mn), zinc (Zn), iron (Fe), cobalt (Co), indium (In), gallium (Ga), and ruthenium (Ru) can be conjugated to quaternary amine groups. Among these metals, Ni, Zn, Fe, Ru, Ir, Ag, Ni, Zn, and Cu have been found to provide antibacterial and antifungal effects. Pt (II) complexes have been found to provide some antibacterial effects, and Pd (II) has been found to provide some level of both antibacterial and antifungal effects. Co, Au, and Ga have also been found to exhibit antibacterial effects. Co and Cu have been found to provide antiviral effects.

Metal-diamine complexes are potent due to their strong chelation, lipophilicity, and metallobiological activity, which allows them to penetrate cells and disrupt cellular metabolism processes. Metal-quaternary amine complexes, on the other hand, can act as a contact inhibitor, binding and disrupting membranes to effectively kill microbes. As will be evident by the subsequent disclosures provided herein, in some embodiments, formation and conjugation of the one or more metal nanoparticles of the pesticide may be facilitated by dissolving and/or reducing a metal compound, such as a copper (II) sulfate pentahydrate or silver nitrate, with a solvent or reducing agent, respectively, and subsequent mixing with the modified CNCs.

It has also surprisingly been discovered that surface adhesion of the pesticide can be increased by increasing the concentration of CNCs in the nanocellulose scaffold. In this regard, it has been discovered that increased concentrations of CNCs promote the formation of a bundled network of CNCs as a result of intra- and intermolecular bonds and van der Waals interactions among CNCs and that metal nanoparticles can be complexed within such bundled networks. Accordingly, in some embodiments, the nanocellulose scaffold includes a plurality of CNCs, where each respective CNC is bound or attracted to at least one other CNC of the plurality of CNCs and the pesticide includes a plurality of metal nanoparticles. In some embodiments, the pesticide includes a CNC concentration of about 5 mg/ml to about 60 mg/ml. In some embodiments, the pesticide includes a metal nanoparticle concentration of about 2 mg/ml.

In some embodiments, the pesticide may be provided as a constituent in a mixture that includes one or more additional constituents. For instance, in some embodiments, the pesticide may be provided in a mixture that includes the pesticide dispersed and diluted with water.

In another aspect, methods for synthesizing a pesticide that can be utilized to treat plant disease are also provided.

An exemplary method for synthesizing a pesticide in accordance with the present disclosure includes steps of: (a) modifying one or more CNCs to include a functional group to which one or more metal nanoparticles can be conjugated; and (b) conjugating the one or more metal nanoparticles to the one or more CNCs.

In some implementations of the method for synthesizing a pesticide, modifying the one or more CNCs includes modifying the one or more CNCs to include a diamine functional group to which the one or more metal nanoparticles can be conjugated. In this regard, and in some implementations, the one or more CNCs are modified by first substituting a hydroxyl group of the one or more CNCs with a tosyl group to form one or more Tos-CNCs, and then subsequently substituting the tosyl group of the one or more Tos-CNCs with a diamine. In various implementations, the respective CNCs of the nanocellulose scaffold can include a single CNC with a plurality of its hydroxyl groups substituted initially by a tosyl group and subsequently with a diamine group or include multiple CNCs with a plurality of their hydroxyl groups substituted initially by a tosyl group and subsequently with a diamine group. In other words, respective CNCs of the nanocellulose scaffold can include multiple hydroxyl groups substituted so that the respective CNCs include multiple diamine groups. Substitution of hydroxyl groups of the respective CNCs of the nanocellulose scaffold can, in some implementations, be achieved using pyridine and p-toluenesulfonyl chloride. In some implementations, tosylated CNCs (Tos-CNCs) can be precipitated (e.g., using ethanol) and lyophilized prior to the tosyl groups of the respective CNCs being replaced with diamine groups. In some implementations, the tosyl groups of the respective CNCs are substituted with TMEDA. In some embodiments, the one or more Tos-CNCs are dispersed in N,N-dimethylformamide prior to being mixed with TMEDA to facilitate substitution of the tosyl groups with diamines.

In some implementations of the method for synthesizing a pesticide, one or more copper nanoparticles are conjugated to the one or more TMEDA-CNCs. In some implementations, the one or more copper nanoparticles are conjugated to the one or more TMEDA-CNCs by first dissolving copper (II) sulfate pentahydrate in water, and then mixing the one or more TMEDA-CNCs to the resulting solution.

In some implementations of the method for synthesizing a pesticide, modifying the one or more CNCs includes modifying the one or more CNCs to include a quaternary ammonium compound that includes a quaternary amine with which the one or more metal nanoparticles can be conjugated. In this regard, and in some implementations, the one or more CNCs are modified by substituting a hydroxyl group of the one or more CNCs with a quaternary compound using glycidyltrimethylammonium chloride (GTMAC) to thereby form one or more Cat-CNCs. In some implementations, the one or more CNCs are modified to include the quaternary ammonium compound by first dispersing the one or more CNCs and NaOH in a solvent and then adding GTMAC to the mixture. In some implementations, the solvent in which the CNCs and the NaOH are dispersed is water. In some implementations, the solvent in which the CNCs and the NaOH are dispersed is a combination of water and dimethyl sulfoxide (DMSO).

In some implementations of the method for synthesizing a pesticide, one or more silver nanoparticles are conjugated to the one or more Cat-CNCs. In some implementations, the one or more silver nanoparticles are conjugated to the one or more Cat-CNCs by mixing silver nitrate (AgNO₃) with the one or more Cat-CNCs and reducing silver nitrate (AgNO₃) with sodium borohydride (NaBH₄).

In some implementations, the method for synthesizing a pesticide may further include combining the pesticide with one or more constituents. For instance, in some implementations, the pesticide may be combined with water to disperse and dilute the pesticide.

The pesticides disclosed herein can be utilized in the treatment of plant disease. Accordingly, in another aspect, the present disclosure further includes methods for treating disease in a plant in which an effective amount of a pesticide consistent with that described above is administered to a plant in need thereof. The pesticide administered can, in various implementations, be any of the various pesticide embodiments described above. Administration of the pesticide can, in some implementations, involve multiple administrations of the pesticide to a plant. In this regard, in various implementations, administration of the pesticide may occur at regular or irregular intervals until the disease has fully subsided, partially subsided, or another desired affect with respect to treatment of the plant has been achieved. Assessment of the effect or progress of treatment may be employed utilizing the same or similar techniques discussed below for identifying a plant as being affected by disease, at risk of being affected by disease, or otherwise in need of treatment.

In some implementations of the method for treating plant disease, the pesticide is administered by spraying the pesticide onto the plant. Depending on the application, various devices for spraying the pesticide can be utilized. For instance, to treat a single or a small number of plants, handheld spraying devices may be utilized, whereas tractor-mounted sprayers or aerial sprayers may be utilized to facilitate the treatment of a large number of plants. A variety of techniques for applying liquid pesticides are known and can be employed in various implementations of the method for treating plant disease. In some implementations, the pesticide may be provided in a mixture with one or more additional constituents, such as inert ingredients, to facilitate administration and/or storage of the pesticide.

In some implementations of the method for treating plant disease, the method further includes a step of identifying a plant as in need of treatment. In various implementations, a plant can be identified as being affected by disease, at risk of being affected by disease, or otherwise in need of treatment via: the identification of physical symptoms indicative of plant disease in the leaves, stems, roots, and/or fruits or flowers of the plant; the identification of pathogens, such as fungal structures (e.g., mold, spores, or fruiting bodies), bacteria, or viral bodies on or within the plant; the identification of pests on or within the plant; or combinations thereof. Such identification may be achieved via: visual inspection; microscopic examination; laboratory testing (e.g., using culture tests, soil and tissue tests), molecular diagnostics (e.g., polymerase chain reaction (PCR) to detect DNA/RNA of particular pathogens, enzyme-linked immunosorbent assay (ELISA) detect proteins of particular pathogens), field diagnostics (e.g., lateral flow rapid tests or pH, moisture, and nutrient meters), or combinations thereof.

In some implementations of the method for treating plant disease, the pesticide is administered to a plant that is infected with Xanthomonas translucens bacteria. Accordingly, in various implementations, the method can involve administration of the pesticide to treat a plant affected by or at risk of being affected by bacterial leaf streak (BLS) disease or bacterial wilt. The pesticides disclosed herein have been found to be particularly effective with respect to treating BLS disease in rainy conditions. Accordingly, in various implementations, the method can include administering the pesticide to plants susceptible to or commonly affected by BLS disease, such as, by way of non-limiting example, wheat, barley, oats, triticale, and rye plants.

The utility of the pesticides disclosed herein is not, however, limited to the treatment of BLS disease. In this regard, Cu-TMEDA-CNC pesticide can also provide fungal protection from downy mildew (grapes, onions), powdery mildew (tomatoes, cucurbits), Septoria leaf spots, black spot, cherry leaf spot, apple scab, peach leaf curl, Botrytis leaf blight, Stemphylium vesicarium, anthracnose, and Phytophthora infestans. In terms of bacterial protection, Cu-TMEDA-CNC pesticide can provide protection from Erwinia (soft rot), Pseudomonas, Xanthomonas leaf spots, fire blight. CNC-CAT-Ag pesticide can also provide fungal protection from anthracnose (Colletotrichum spp.) in pepper, powdery mildew in cucumber and pumpkin, early blight (Alternaria solani) in tomato, and Phytophthora parasitica (oomycete) on tobacco and citrus. As a bacterial protection, this system can protect from Xanthomonas perforans (bacterial spot) on tomato, Erwinia carotovora and Ralstonia solanacearum (soft rot, wilt), and Pseudomonas syringae blight in wheat. Further as in terms of antiviral protection, CNC-CAT-Ag pesticide can protect from Bean yellow mosaic virus (BYMV) in faba bean, Tomato mosaic virus (ToMV), Potato virus Y (PVY) in tomato, Tomato spotted wilt virus (TSWV), Banana bunchy top virus (BBTV), Sunhemp rosette virus (SHRV), and Cassava leaf spot virus. Accordingly, in various implementations, the pesticides disclosed herein can be administered plant of the above-identified type, plants affected or at risk of being affected by the above-identified diseases, and/or plants infected with the above-identified bacteria.

While reference is sometimes made to specific plant diseases, plant varieties, and infections in the present disclosure to facilitate explanation of the pesticides and methods disclosed herein and certain embodiments or implementations thereof, such reference is not intended to strictly limit the use of the pesticides and methods disclosed herein to such enumerated diseases, plant varieties, and infections. Rather, the pesticides and methods disclosed herein may find further utility with a variety of other plant diseases, plant varieties, and/or infections.

While the terms used herein are believed to be well understood by those of ordinary skill in the art, certain definitions are set forth to facilitate explanation of the presently disclosed subject matter.

Unless defined otherwise, all technical and scientific terms used herein have the same meaning as is commonly understood by one of skill in the art to which the invention(s) belong.

All patents, patent applications, published applications and publications, GenBank sequences, databases, websites and other published materials referred to throughout the entire disclosure herein, unless noted otherwise, are incorporated by reference in their entirety.

Where reference is made to a URL or other such identifier or address, it is understood that such identifiers can change and particular information on the internet can come and go, but equivalent information can be found by searching the internet. Reference thereto evidences the availability and public dissemination of such information.

Although any methods, devices, and materials similar or equivalent to those described herein can be used in the practice or testing of the presently disclosed subject matter, representative methods, devices, and materials are described herein.

The present application can “comprise” (open ended) or “consist essentially of” the components of the present invention as well as other ingredients or elements described herein. As used herein, “comprising” is open ended and means the elements recited, or their equivalent in structure or function, plus any other element or elements which are not recited. The terms “having” and “including” are also to be construed as open ended unless the context suggests otherwise.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, in some embodiments ±0.1%, in some embodiments ±0.01%, and in some embodiments ±0.001% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, reference to a metal nanoparticle being “conjugated to” another component or aspect of a pesticide of the present disclosure, such as the nanocellulose scaffold or a particular functional group of a CNC in the nanocellulose scaffold, means that the metal nanoparticle is combined with such component or aspect, such that the metal nanoparticle and such component or aspect of the pesticide are held in association with each other by a chemical or physical force. In various embodiments, a metal nanoparticle may be conjugated to the nanocellulose scaffold, or one or more functional groups of one or more CNCs of the nanocellulose scaffold, via various chemical bond(s) and electrostatic force(s).

As used herein, the term “treatment” is inclusive of prophylactic treatment and therapeutic treatment. As would be recognized by one of ordinary skill in the art, treatment that is administered prior to clinical manifestation of a condition is prophylactic (i.e., it protects the subject against or reduces the risk of the subject developing the condition). If the treatment is administered after manifestation of the condition, the treatment is therapeutic (i.e., it is intended to diminish, ameliorate, control, or maintain the existing condition and/or side effects associated with the condition). The terms relate to management of a subject, such as a plant, with the intent to substantially cure, ameliorate, stabilize, or substantially prevent a condition of interest (e.g., a disease), including but not limited to prophylactic treatment to preclude, avert, obviate, forestall, stop, or hinder something from happening, or reduce the severity of something happening, especially by advance action. As such, the terms treatment or treating include, but are not limited to: inhibiting the progression of a condition (e.g., a disease) of interest; arresting or preventing the development of a condition of interest; reducing the severity of a condition of interest; ameliorating or relieving symptoms associated with a condition of interest; causing a regression of the condition of interest or one or more of the symptoms associated with the condition of interest; and preventing a condition of interest or the development of a condition of interest. The term includes active treatment, that is, treatment directed specifically toward the improvement of a condition of interest, and also includes causal treatment, that is, treatment directed toward removal of the cause of the condition of interest.

As used herein, the term “effective amount” refers to an amount that is sufficient to achieve the desired prophylactic or therapeutic result or to have an effect on undesired symptoms. The specific effective amount for any particular subject may depend upon a variety of factors including the particular risk or condition being treated and the severity of the condition; the specific composition employed; the age and general health of the subject; the time of administration; the route of administration; the duration of the treatment; compounds used in combination or coincidental with the specific pesticide employed and like factors well known in the arts. For example, it is well within the skill of the art to start doses of a compound at levels lower than those required to achieve the desired therapeutic effect and to gradually increase the dosage until the desired effect is achieved. If desired, the effective daily dose can be divided into multiple doses for purposes of administration.

As will be recognized by one of ordinary skill in the art, the terms “suppression,” “suppressing,” “suppressor,” “inhibition,” “inhibiting” or “inhibitor” do not refer to a complete elimination of a value in all cases. Rather, the skilled artisan will understand that the term “suppressing” or “inhibiting” refers to a reduction or decrease in a measured value, qualitatively or quantitatively. Such reduction or decrease can be determined relative to a control or a prior status of a subject. In some embodiments, the reduction or decrease relative to a control or the prior status of a subject can be about a 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% decrease.

As used herein, “optional” or “optionally” means that the subsequently described event or circumstance does or does not occur and that the description includes instances where said event or circumstance occurs and instances where it does not. For example, an optionally variant portion means that the portion is variant or non-variant.

The presently disclosed subject matter is further illustrated by the following specific but non-limiting examples. The following examples may include compilations of data that are representative of data gathered at various times during the course of development and experimentation related to the present invention.

### EXAMPLE

### Silver and Copper Nanoparticle Stabilization on Chemically Modified Cellulose for Treatment of Plant Disease

The studies underlying the present example were carried out to develop and test a bio-based antibacterial system that can adhere to a plant, establish antibacterial protection, and reduce the number of antibacterial applications required to treat plant disease.

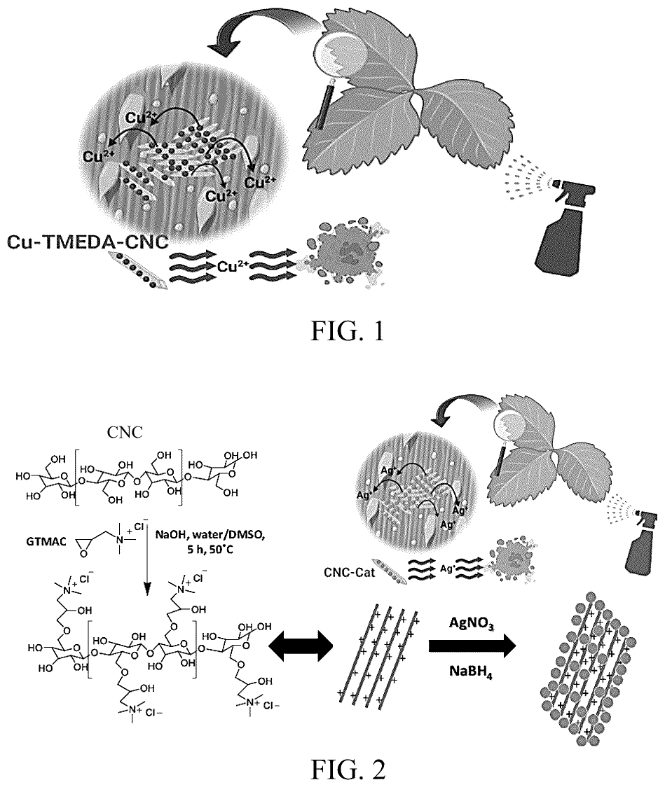

In the studies underlying this example, nanocellulose was chosen to facilitate stabilization, conjugation, and complexing of metal nanoparticles, promote attachment to the leaf surfaces of plants, and extend the release of metal ions for antibacterial applications (FIGS. 1-2). Nanocellulose is extracted from natural, renewable sources. Due to its multivalency, cellulose nanocrystal (CNC) was selected to serve as a bio-based cellulosic nanomaterial scaffold for scaffold construction and testing. Advantages with respect to the use of CNCs as a scaffold (i.e., a supporting framework) for metal nanoparticles include the material's large surface area, high aspect ratio, and many reactive hydroxyl functional groups, which allow CNCs to be functionalized in many different ways. Purification processes following functionalization are also easier than those used for other polymers. In addition, functionalized CNCs can be loaded at high contents with good dispersion in the matrix due to the high degree of functionalization. The facile and orthogonal functionalization of CNCs possesses multiple unique advantages over other biopolymers, such as a simple synthesis process, flexible tunability, and superior mechanical and thermal properties. Due to these advantages, CNCs tend to promote conjugation/complexation with metals or biomolecules in a multivalent fashion. Due to the availability of a large number of hydroxyl groups in CNCs, a network structure can develop under the influence through intra- and intermolecular bonds as well as van der Waals interaction between the crystals.

The abundant hydroxyl groups of CNCs were chemically modified to develop diamine and quaternary amine to stabilize the metal nanoparticles. CNCs were modified using (1) toluene sulfonyl chloride and (2) trimethylethylenediamine (TMEDA) to develop diamine groups on its structure. The presence of diamine functional groups in the CNCs initiated complexation with free Cu ions. Copper (Cu) as metal ions were selected for their antibacterial application. XPS and FTIR analysis was studied to support the modification process. Formation of Cu complexation process supported by UV-Vis spectral analysis and visualized by TEM imaging. Bare eyes can see the successful formation of Cu complex within CNC nano-scaffolds by observing the change of color from deep blue to greenish blue. Surface adhering properties of CNCs were studied by measuring contact angle and surface tension and calculating surface-liquid adhesion energy. A surface tilting study was introduced to mimic the natural inclination of the plant leaf. SEM imaging study was performed after spraying the solution, drying, and washing with water to replicate the natural washing process. Antibacterial properties of modified CNCs and Cu complex modified CNCs formulations were explored.

Another metal nanoparticle system-silver nanoparticle (Ag NP) conjugated to modified CNCs—was also selected for a similar antibacterial and adhesion study. CNCs were chemically functionalized using glycidyltrimethylammonium chloride (GTMAC) to graft quaternary amine on its backbone. The importance of water: dimethylsulfoxide (DMSO): GTMAC ratios during the reaction was investigated in order to get the highest amount of quaternary amine grafting. Positively charged quaternary amine in CNCs enables them to become cationized CNCs. The higher the number of quaternary amine functionalization on CNC, the greater the cationization effect of modified CNCs. Zeta potential measurement, elemental N/C ratio, and FTIR analyses were performed to support the cationization process. In the study, silver nanoparticles (Ag NPs) were selected for the antibacterial application. Silver nitrate was reduced with sodium borohydride, forming nascent zero (0) valent Ag NPs after being stabilized within cationized CNC. This nucleated Ag product will undergo an isotropic growth phase, forming Ag⁰ nanoparticles (Ag NPs) within the CNC structure. The formation of Ag NPs within the CNC structure can be characterized by UV-Vis spectroscopy and visualized by TEM imaging. This change due to the formation of Ag NPs within CNC nano-scaffolds can also be observed with bare eyes by visualizing the change of color to a brown solution.

Surface stickiness properties of Ag-CNC were investigated with a contact angle study and measuring contact angle on wheat leaves, surface tension, surface adhesion, and surface-liquid adhesion energy. Similar to the Cu-CNC adhesion study, surface tilting effects were also investigated to replicate the natural inclination of the plant leaf. SEM imaging is carried out after spraying the solution, drying, and washing with water to visualize the surface adhering properties. Metal ion release from CNC-stabilized Ag NPs was performed with Atomic Absorption spectroscopy to investigate the release mechanism from the modified structure. Antibacterial properties of modified CNC and CNC-stabilized Ag NP were investigated.

A greenhouse study was conducted to perform real-time bactericide application of CNC-Cat stabilized Ag NP complexes (CNC-Cat-Ag NP) and compared with a mixture of unconjugated CNC and commercially available Ag NPs, and water alone. This experiment investigated the importance of metal nanoparticles chemically complexed with CNCs. CNC-Cat-Ag NP attaches to the leaf surface and release Ag⁺ ions without releasing Ag NPs, inhibiting bacterial infections (FIG. 2). A similar greenhouse study producing similar results was conducted with respect to TMEDA-CNC stabilized Cu NP complexes (Cu-TMEDA-CNC), a mixture of unconjugated CNC and commercially available Cu NPs, and water alone.

### Materials and Methods

Materials. Cellulose nanocrystals (CNCs) in the freeze-dried powder form (1 wt % sulfur and sodium form) [(C₆H₁₀O₅)ₓ(C₆H₉O₄SO₄Na)_{y}] were purchased from the Process Development Center of the University of Maine. These CNCs have a rod-like shape with a diameter of 3-20 nm and a length of 150-200 nm³⁹. They also possess a high axial stiffness (˜150 GPa), outstanding tensile strength (˜7.5 GPa), high thermal stability (˜300° C.), superior aspect ratio (10-100), and a low density (˜1.6 g/cm³)⁵⁵. P-toluenesulfonyl chloride (99%), pyridine (anhydrous, 99.8%), N,N-dimethylformamide (DMF) (ACS reagent, ≥99.8%), N,N,N′-trimethylethylenediamine (TMEDA) (97%), ethanol (99.8%) and copper (II) sulfate pentahydrate (CuSO₄·5H₂O) (ACS reagent, ≥98.0%) were purchased from Sigma Aldrich and used as received. We have purchased Sodium Hydroxide (NaOH) (reagent grade, ≥98%, anhydrous), glycidyltrimethylammonium chloride (GTMAC) (technical, >90%), Dimethyl sulfoxide (DMSO) (ACS reagent, >99.9%), Silver nitrate (AgNO₃) (ACS reagent, ≥99.0%) and Sodium borohydride (NaBH₄) (powder, ≥98.0%) from Sigma Aldrich. Commercially available silver nanoparticle powder was purchased for comparison study from Inframat® Advanced Materials (99.95% purity, ˜150 nm).

Tosylation of CNCs. Tosylation functionalization of CNCs (FIG. 3) was performed following a previously reported method. Dry powder of CNCs (500 mg) was dispersed in pyridine (10 mL) under stirring at a low temperature (˜10° C.). P-toluenesulfonyl chloride (tosyl chloride) (900 mg, 5 mmol) was added to the dispersion and stirred for 2 days. The tosylation reaction was carried out in pyridine to modify only the surface functional group (—OH group) of CNCs and retain their crystalline structure. The tosylated CNC (Tos-CNC) was precipitated by adding 100 mL of ethanol and washed with ethanol five times. The product was dried overnight at room temperature and lyophilized afterward to obtain the final Tos-CNCs in powder form.

TMEDA Reaction on Tos-CNCs. Tos-CNCs (500 mg) were dispersed in 20 mL DMF and poured into an Ace pressure tube. TMEDA (5 mL) was added into the pressure tube under stirring. The pressure tube was sealed and heated at 90° C. for 3 days until the mixture turned brown. Water (50 mL) was added to precipitate the TMEDA functionalized CNCs (TMEDA-CNCs), and the product was washed with ethanol five times using centrifugation. Final TMEDA-CNCs (FIG. 4) were dialyzed against DI water and lyophilized afterward to obtain TMEDA-CNCs powder.

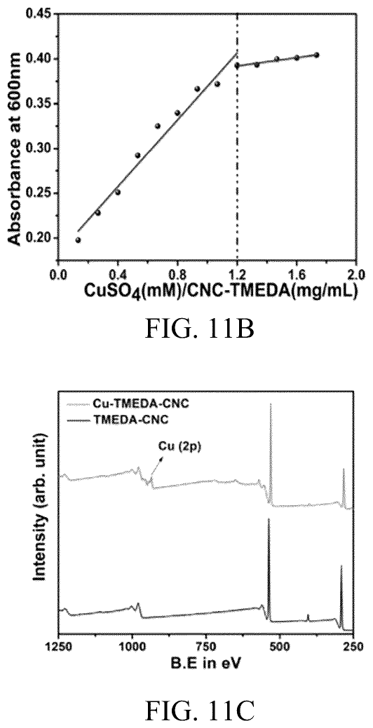

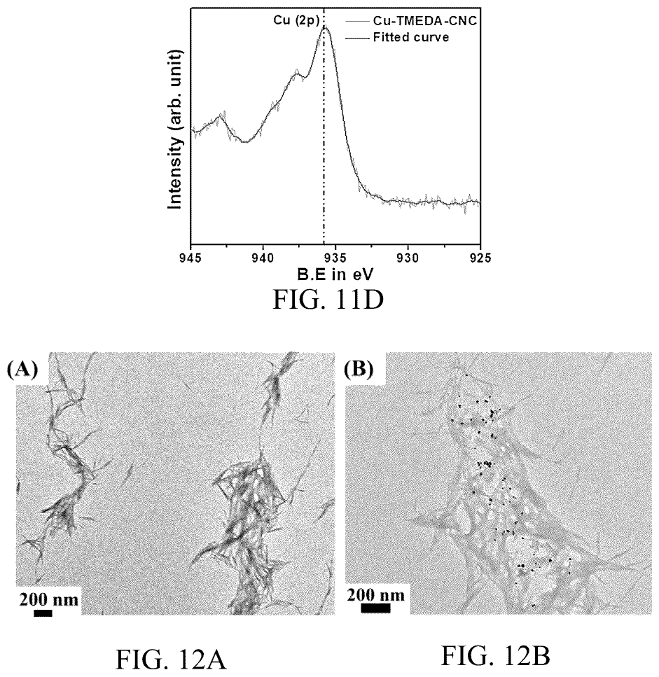

Copper Complexation with TMEDA-CNCs and Elemental Analysis. Copper (II) sulfate pentahydrate (CuSO₄·5H₂O) was dissolved in water, and TMEDA-CNCs were added to the solution. An immediate color change of the solution (blue to green blue) was observed after the mixing. UV-Vis spectroscopy was performed on the solution to confirm the formation of copper complexation through ligands using a Cary 5000 spectrometer. Formation of the complexation Cu-TMEDA-CNC can be validated by observing peak shifting on the spectrum after adding TMEDA-CNCs. A spectrophotometric titration plot was developed at different TMEDA-CNC to CuSO₄ ratios using UV-Vis spectral analysis. XPS was used to find the binding energy for the complexation form of Cu with TMEDA-CNCs (FIG. 11B).

Cationization of CNCs. Following previous protocols (FIG. 2), dry powder of CNCs (200 mg) and 25 mg of NaOH were dispersed in (separately 5, 10, and 15 mL) of variable content of deionized water, and 10 mL of GTMAC was added to the system. The mixed solution was heated at 50° C. for 5 h under stirring conditions.

To understand the effect of water or DMSO solvent in the cationization process, we have used DMSO/water as the ratio for separate experiments. Dry powder of CNC (200 mg) and 25 mg of NaOH were dispersed in (separately 9, 8, and 5 mL) of variable content of deionized water and DMSO solvent (1, 2, and 5 mL, respectively). GTMAC (10 mL) was added to the system and heated at 50° C. for 5 h under stirring conditions.

The reactions were stopped by maintaining pH at 7, and 80% ethanol was added to continue with centrifugal wash 3 times. The final pallet was dried overnight at room temperature and freeze-dried for 24 h.

Elemental Analysis on Cationized CNCs. We have investigated N/C ratio with elemental analysis after grafting quaternary amine on CNCs. Elemental analysis was done in Atlantic microlab where CHNS analyses are quantified (percent by weight determinations, +/−0.3% for accuracy and precision) by combustion techniques (minimum 5 mg of sample required and dried under vacuum).

Surface Charge Investigation with Zetasizer. Surface zeta potential was measured on the sample with Malvern Zetasizer Nano-ZS90 zetasizer. The dried sample was dispersed in water and continued for zeta potential measurement at room temperature.

Silver Nanoparticle Synthesis and Stabilization with Cationized CNC.

Dry cationized CNCs of 200 mg were dispersed very well in 20 mL of 100 mM AgNO₃ solution (AgNO₃ and deionized water), and the color turned into a milk-white homogenous solution. Afterward, 20 mL of 10 mM NaBH₄ solution was added under the stirring condition to the milk-white solution, and the color became a dark brown solution. The final solution was kept overnight to let borane/diborane (BH₃/B₂H₆) and other gas out. The final product was centrifuged for washing and a collected pellet to redisperse in fresh water.

UV-Vis Spectral Analysis to Support the Synthesis of Ag Nanoparticles. UV-Vis spectroscopy was used to identify the formation of silver nanoparticles (Ag NPs). Ultraviolet-Visible-Near Infrared Spectrometer (UV-VIS-NIR) Varian Cary 5000 was used to investigate the spectral analysis by scanning 800 to 200 nm spectral range. The calibration curve was evaluated with a known concentration of commercially available Ag nanoparticles by dispersing them in water. The titration plot was developed using UV-Vis spectral analysis based on the amount of NaBH₄ needed to reduce AgNO₃ solution for Ag nanoparticle synthesis.

Fourier-transform Infrared (FTIR) Spectroscopy on Tos-CNCs, TMEDA-CNCs, pristine CNC, and Cationized CNCs. To validate the functionalization of Tos-CNCs, TMEDA-CNCs, pristine CNC and Cationized CNCs, FTIR was performed on the dry powder products using a Thermo Scientific Nicolet 8700 system between 4000-500 cm⁻¹ via 32 repetitive scans.

X-ray Photoelectron Spectroscopy (XPS) on Tos-CNCs, TMEDA-CNCs, Pristine CNC, and Cationized CNCs. XPS was also used to validate the functionalization of Tos-CNCs, TMEDA-CNCs, pristine CNC and Cationized CNCs by detecting the presence of sulfur and nitrogen elements. The powder samples were mounted on a copper well plate, and the chamber pressure was decreased to 1×10⁻⁷ mTorr (24 h prior to the measurement). The X-ray spot size was kept at 200 microns, and the flood gun was turned on during analysis to minimize the surface charging of the samples. Survey scans were conducted at pass energy of 200 eV, 10 scans, a dwell time of 10 ms, and an energy step size of 1 eV. High-resolution scans were conducted for N, S, and Cu at a pass energy of 50 eV, 10 scans, a dwell time of 50 ms, and an energy step size of 0.1 eV.

Transmission Electron Microscopy (TEM) Imaging to Visualize copper complexation with TMEDA-CNCs and Ag NP stabilization on Cationized CNCs. TEM was performed to observe the copper complexation within the TMEDA-CNC and silver nanoparticle decoration on the surface of cationized CNC networks. A drop of the diluted TMEDA-CNC/CuSO₄ and Ag NP-Cationized CNC solutions were placed on a 300-mesh formvar-carbon coated copper grid (Ted Pella Inc., Redding, California, USA) for two minutes, and the excess liquid on the grid was absorbed using filter paper. The sample was stained using phosphotungstic acid (0.1%, pH 7-8) for two minutes. Images were collected using a JEOL JEM-1400 Flash transmission electron microscope (JEOL USA).

Scanning Electron Microscopy (SEM) Imaging on CNC-coated Wheat Leaf. Cu-TMEDA-CNCs complexation and Ag NP-Cationized CNC solutions in water were sprayed on wheat leaves separately and dried for 2 hrs. The leaves were submerged in water for a gentle rinse. The leaves were again dried, attached to cylindrical aluminum mounts with conductive carbon adhesive (Ted Pella, Redding, California, USA), and sputter coated (Cressington 108auto, Ted Pella, Redding, California USA) with a thin layer of gold. SEM images were obtained using a JEOL JSM-6490LV SEM (JEOL USA) at an accelerating voltage of 15 kV.

For the field effect electron microscopy (FESEM) study, samples were mounted on aluminum mounts using carbon adhesive tabs/tape and then coated with a conductive layer of carbon using a high-vacuum evaporative coater (Cressington 208c, Ted Pella Inc., Redding, California, USA). Images were obtained using a JEOL JSM-7600F SEM (JEOL USA) operating at 2 kV.

Surface Adhesion Properties. The contact angle (θc) of the complexation solution on the wheat leaf surface and the surface tension at the liquid-vapor interface (γ_{LV}) were measured using a KRUSS (Model: DSA1005, Serial: 30009734, Germany) drop-shape analyzer. The wheat leaf was taped on the sample stage to prepare a flat and level surface for the measurement. TMEDA-CNCs, CuSO₄ at different concentrations, and variable concentrations of cationized-CNC (CNC-Cat) were dropped (volume applied=5 μL) on the surface using a sessile needle (needle diameter 0.5 mm). KRUSS software tracked the surface of the droplet with respect to the leaf surface baseline and calculated the contact angle (θ_{C}). Surface tension γ_{Lv} of the droplet (largest droplet formation at syringe nozzle just before dripping from the nozzle) was measured using a KRUSS drop shape analyzer (pendant needle was used, diameter 1.8 mm). The solid-liquid adhesion energy per unit area (δW_{SLV}) of the droplet was calculated using the following Young-Dupré equation (1):

$$δ {W}_{SLV} = {γ}_{LV} ( 1 + Cos θ C ) \qquad ( 1 )$$

Additionally, advancing (θ_{A}) and receding angles (θ_{R}) were measured when the leaf surface was tilted at 0°, 45°, 60°, and 90° angles. The two angles are important parameters to study because plant leaves are normally at an inclined angle in the natural environment. On a slope, the contact angle of the droplet at the lowest point (i.e., the largest angle) is defined as the advancing contact angle (θ_{A}), and the angle at the highest point (i.e., the smallest angle) as the receding contact angle (θ_{R})_{60,}_{⁶¹}. The difference between θ_{A} and θ_{R} defines a liquid solution's stability and adhesiveness properties on the leaf surface. The lower the difference, the stronger the adhesion⁶⁰.

Antibacterial Study on Xanthomonas translucens pv. undulosa. Wilbrink's agar (WBA) media plate was used to culture the Xanthomonas translucens pv. undulosa fungus. Peptone (5 g), sucrose (10 g), dipotassium hydrogen phosphate trihydrate (K₂HPO₄·3H₂O, 0.66 g), magnesium sulfate heptahydrate (MgSO₄·7H₂O, 0.25 g), sodium sulfite (Na₂SO₃, 0.05 g), and agar (15 g) were mixed using a magnetic stirrer in 1 L of autoclaved water until complete solution. The solution was autoclaved, poured into plates, and left to cool down naturally. Finally, the obtained WBA plates were stored at 4° C. for antibacterial study.

Cotton filter paper disks (0.638±0.007 cm diameter) were punched from standard filter paper and autoclaved. Bacterial strain Xanthomonas translucens pv. undulosa was cultured freshly. A small amount of strain was collected from the culture and diluted with fresh autoclaved water to reach a concentration of optical density (OD_{Tos})˜0.196. This diluted bacterial solution (100 μL) was uniformly spread on the WBA media using a spreader spatula. The autoclaved filter paper disks were soaked in the individual sample solution and placed on the bacterial culture-coated media. These media plates were stored at 30° C. for 2 days to allow the bacterial culture to grow. The zone of inhibitions was measured using the ImageJ analysis tool.

Greenhouse Study on Wheat Plants Under Environmental Effects. A first greenhouse study was conducted to compare the disease severity between a first conjugated bactericide (CNC-Cat-Ag NPs), a first unconjugated bactericide (CNC and Ag NPs mixture), and water. In the study, seeds of RB07, a susceptible wheat line, were planted in cones. The plants were grown in the greenhouse under 16 h light and 23° C. temperature for two weeks. The plants were inoculated with the BLS-P3, and the inoculum was prepared according to the protocol described in Adhikari et al. 2011 and Adhikari et al. 2012 with a minor modification. The bacterial strains were streaked from the stock culture in a −80° C. freezer onto Wilbrink's agar (WBA) plates and grown at 28° C. for 48 h. Before the inoculation, the treatments were divided into two groups, washed (A5_CNC_Cat_Ag, A6_CNC_Cat_Ag, A1_control, A2_control, A9_water) and non-washed (A8_CNC_Cat_Ag, A7_CNC_Cat_Ag, A3_Control, A4_control, A10_water). In both groups, “CNC-cat-Ag NPs” was represented as a conjugate sample, and “control” was represented as an unconjugated sample (CNC and Ag NP mixture). In contrast “water” was represented as a positive control. First, each group was sprayed with the conjugate bactericidal sample or non-conjugate bactericidal sample, each with 2 mg/ml equivalent Ag NP concentration or water only control. The washed group (A5_CNC_Cat_Ag, A6_CNC_Cat_Ag, A1_control, A2_control, A9_water) washed with water after the spraying while the non-washed group (A8_CNC_Cat_Ag, A7_CNC_Cat_Ag, A3_Control, A4_control, A10_water) did not wash with water after spraying. After washing, the plants were kept in a greenhouse room for 1 h to dry. After 1 hour of drying, both the groups, washed and non-washed, were sprayed with bacterial inoculum (P3) at the OD=0.5 concentration. After inoculation, the plants were put into the misting chamber for two days allowing the disease development. After the misting period, the plants were transferred to a growth chamber and kept for 3 days at 28° C. and 14 h light. The plants were scored after 5 days of inoculation using a disease scoring scale of 0 to 5 as well as based on the percentage of the diseased area on leaves 63.

A second greenhouse study was conducted to compare the disease severity between a second conjugated bactericide (CNC-TMEDA-Cu NPs), a second unconjugated bactericide, and water. The treatments were divided into two groups, washed (A5_CNC_TMEDA_Cu, A6_CNC_TMEDA_Cu, A1_control, A2_control, A9_water, A10_water) and non-washed (A8_CNC_TMEDA_Cu, A7_CNC_TMEDA_Cu, A3_Control, A4_control, A11_water, A12_water). In both groups, “CNC_TMEDA_Cu NPs” was represented as a conjugate sample, and “control” was represented as an unconjugated sample (CNC and commercially available CuSO₄ mixture). In contrast “water” was represented as a positive control. First, each group was sprayed with the conjugate bactericidal sample or non-conjugate bactericidal sample, each with 2 mg/ml equivalent Cu NP concentration or water only control. The washed group (A5_CNC_TMEDA_Cu, A6_CNC_TMEDA_Cu, A1_control, A2_control, A9_water, A10_water) was washed with water after the spraying, while the non-washed group (A8_CNC_TMEDA_Cu, A7_CNC_TMEDA_Cu, A3_Control, A4_control, A11_water, A12_water) was not washed with water after spraying. After washing, the plants were kept in a greenhouse room for 1 h to dry. After 1 hour of drying, both the groups, washed and non-washed, were sprayed with bacterial inoculum (P3) at the OD=0.5 concentration. After inoculation, the plants were put into the misting chamber for two days, allowing the disease to develop. After the misting period, the plants were transferred to a growth chamber and kept for 3 days at 28° C. and 14 h light. The plants were scored after 5 days of inoculation based on the percentage of the diseased area on leaves.

### Results

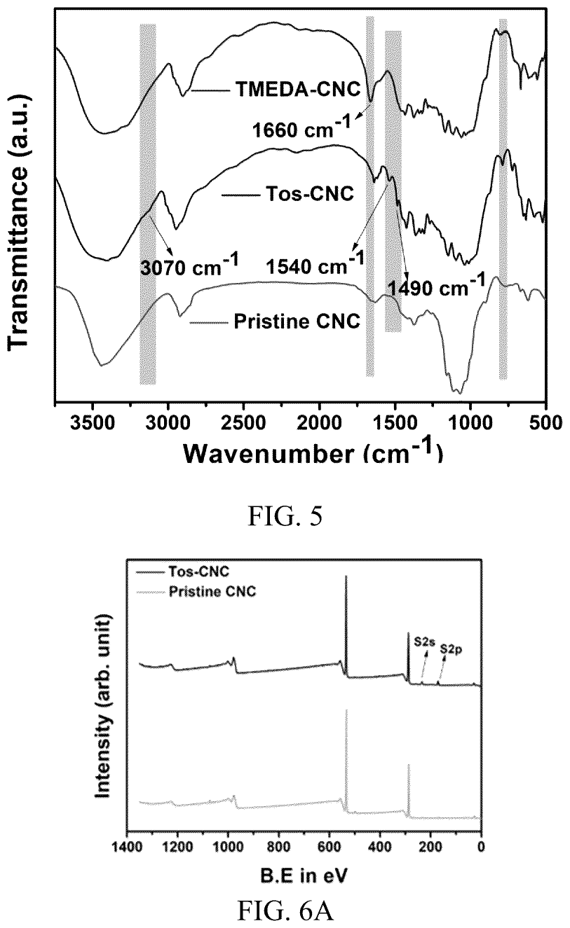

FTIR and XPS Analysis on Tos-CNCs, TMEDA-CNCs, and CNC-Cat. FIG. 5 shows FTIR spectra of the absorption bands of pristine CNCs, Tos-CNCs, and TMEDA-CNCs. In the case of Tos-CNCs, absorption bands occur at 3070, 1540, 1490, and 815 cm⁻¹, which are attributed to aromatic rings of the tosylate group. The two bands at 1342 and 1170 cm⁻¹ are attributed to (vSO₂) in the presence of the tosyl groups. In TMEDA-CNCs, diamine groups replace the tosyl groups, and this replacement is confirmed by the removal of the aromatic ring absorption bands at 1540, 1490, and 3070 cm⁻¹ after the TMEDA functionalization on Tos-CNCs, whereas amide band at 1660 cm⁻¹ arises after diamine conjugation on the CNC backbone.

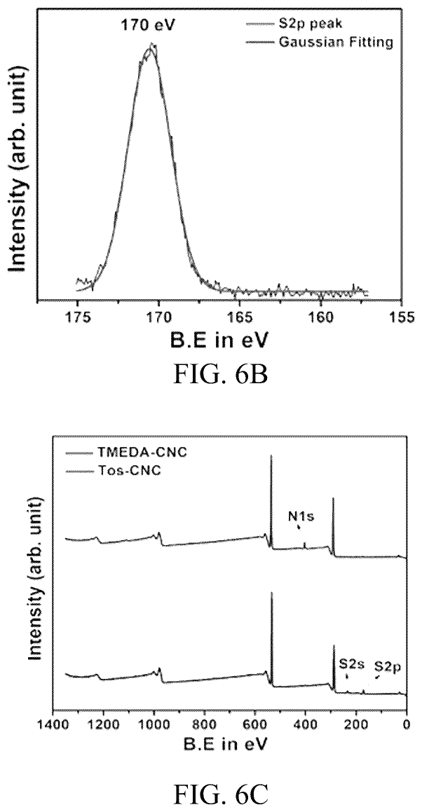

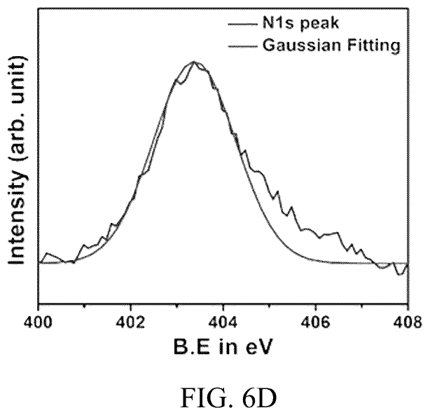

Furthermore, XPS analysis supports the modifications of Tos-CNCs and TMEDA-CNCs from pristine CNCs (FIGS. 6A-6D). After the tosylation of CNCs, the presence of tosyl groups on CNCs is confirmed by the two peaks at 234 eV (S2s) and 170 eV (S2p). After the TMEDA functionalization, the replacement of the tosyl groups by the diamine groups is confirmed by the absence of the 234 eV (S2s) and 170 eV (S2p) peaks and the development of the peak at 403 eV due to the conjugation of the hydrogenated amine or charged amine.

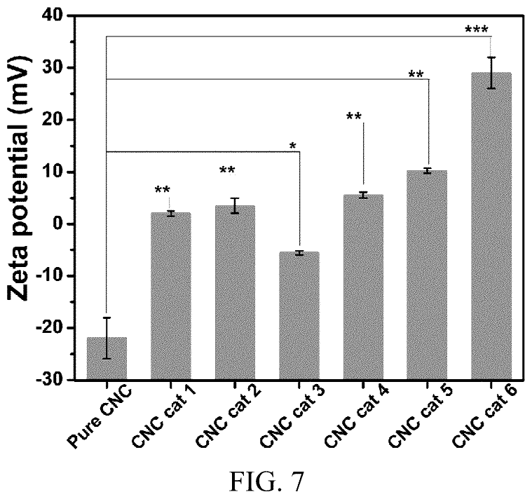

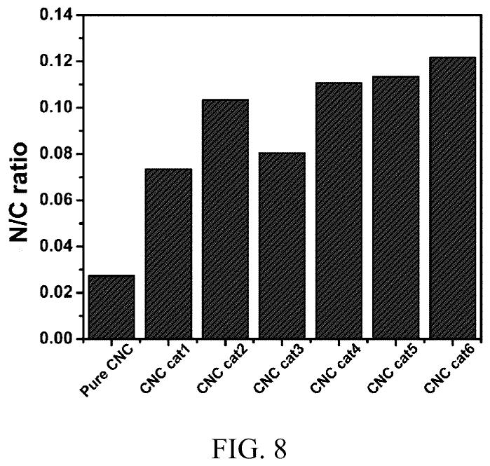

FIG. 7 demonstrates that the zeta potential fluctuations depend on reaction solvent ratios. The Zeta potential of pristine CNCs in water suspension was found with −21.97±3.95 mV surface charge, which attributed due to the presence of 99 wt % OH groups in its structure. Due to functionalization under 2:1 ratio of GTMAC and DI water system, the zeta potential value jumped to 2.02±0.49 mV due to the conjugation of the quaternary amine group. The ratio of GTMAC and water played a vital role in the contribution of cation charge on CNCs. For GTMAC and water ratios of 1:1 and 1:1.5 showed zeta potential of 3.51±1.48 mV and −5.58±0.39 mV, respectively. This result showed that only GTMAC and water system 1:1 showed a higher cationization effect. The additional addition of water decreased the cationization effect. Whereas GTMAC and (DI water: DMSO-9:1) system ratio of 1:1 showed 5.60±0.59 mV zeta potential, higher than the GTMAC: DI water 1:1 formulation alone. This result indicated that the addition of DMSO enhanced the cationization effect on CNCs. Similarly, GTMAC and (DI water:DMSO=4:1) system ratio of 1:1 showed 10.22±0.49 mV zeta potential with further elevation. Finally, the GTMAC and (DI water:DMSO=1:1) system ratio of 1:1 showed 28.99±2.96 mV zeta potential, the highest zeta potential from all formulations. It has been previously reported that the presence of organic solvent decreased the availability of water molecules in the region of cationization agent. This promoted a reduction in hydrolysis reaction and enhanced the cationization efficiency. It has also been reported that a high amount of organic solvent instead of any water molecule produced an absorption issue in the solvent-reagent system by an insoluble mixture of CNCs/NaOH. For this reason, a certain amount of water molecule promotes the diffusion and dispersion of GTMAC along with good absorption of CNCs/NaOH mixture. A certain critical amount of water promotes solubilization of NaOH and activates the hydroxyl group in CNCs during cationization. The zeta potential result after the cationization process was also validated by N/C ratio analysis from elemental analysis on dry cationized CNC samples (FIG. 8). The sample with the highest zeta potential was selected for the stabilization of silver nanoparticles (Ag NP).

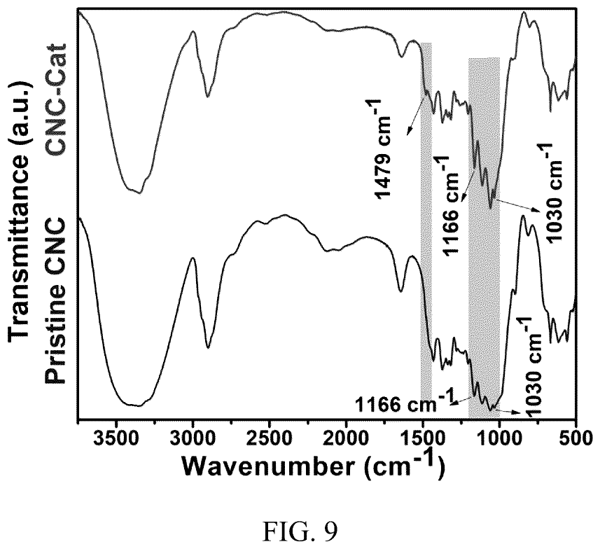

Furthermore, FTIR data supported the successful CNC modification with cationized form (CNC-Cat) (FIG. 9). The intensity of ether bands between 1030 cm⁻¹ and 1166 cm⁻¹ was found to be increased compared to pristine CNCs. This result provided evidence of GTMAC functionalization on pristine CNC. Additionally, a band at 1479 cm⁻¹ developed after functionalization which is attributed due to the CH₂ bending vibration and methyl groups of GTMAC.

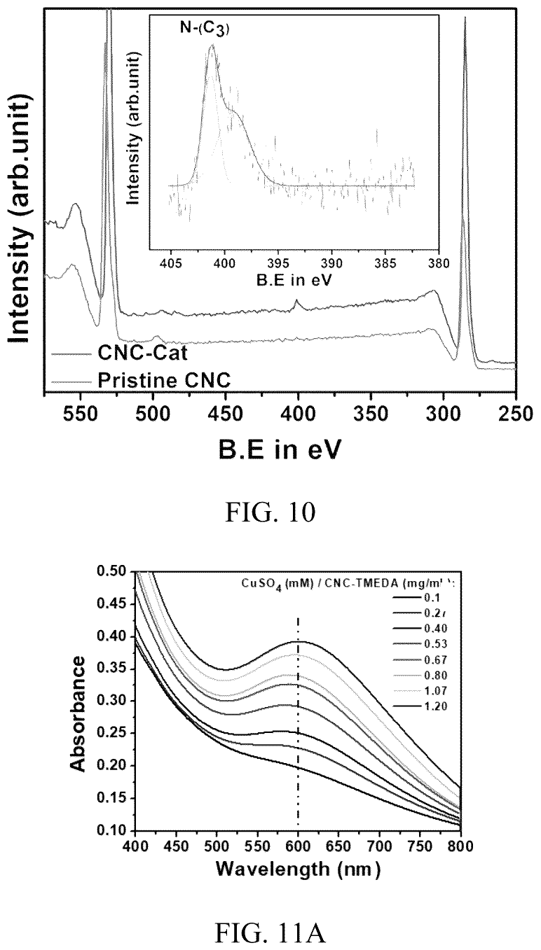

XPS analysis on modified cationized CNC (CNC-Cat) was performed to understand the state of amine groups after functionalization. From FIG. 10, it is found that the N1s peak developed at 401.27 eV after cationization modification. This peak is attributed to bound quaternary amine on the structure of modified CNC backbone.

UV-Vis Spectroscopy and XPS Analyses on Copper Complexation Formation. Copper (Cu) complexation formation with diamine ligand was validated by UV-Vis spectral analysis (FIG. 11A). UV-Vis was performed from 800 to 200 nm on CuSO₄, and the broad peak at 800 nm is characteristic of ionic copper solution. This peak is shifted to 600 nm (FIG. 11A) due to a d-to-d electron transition during the formation of the Cu complex with the diamine groups of TMEDA-CNCs in a square planar geometry formation. A strong peak at 264 nm is attributed to the ligand-to-metal charge-transfer (LMCT) transition and the Cu complexes promoting high-intensity π-π electron transitions in the UV region. A spectrophotometric titration plot was conducted by measuring the absorbance at 600 nm under an increasing Cu ion concentration to TMEDA-CNCs ratio. FIG. 11B shows that ˜191 ug CuSO₄ (1.2 mM) can form complexation with each mg of TMEDA-CNCs.

Furthermore, XPS results also confirm the complexation of Cu with TMEDA-CNCs. FIGS. 11C and 11D show that the Cu (2p) peak at 935.9 eV arises after its complexation to the TMEDA-CNCs ligand. Before the complexation, Cu alone in its oxide form exhibits the Cu (2p) peak at 933 eV. The binding energy upshifted 2.9 eV after the complexation and the formation of a square planar geometry.

TEM imaging of Cu complexation with TMEDA-CNCs. The formation of Cu complex/Cu nanoparticles on modified TMEDA-CNCs can be observed in FIGS. 12A and 12B. Pristine CNCs as rod-like nanocrystals bundle together due to their large number of hydroxyl groups after drying on the TEM sample grid (FIG. 12A). In the case of Cu-TMEDA-CNCs, the Cu nanoparticles, black dots with a size of 5-50 nm, can be clearly seen attached to/caged in the CNC bundle networks (FIG. 12B). Even after functionalization, many unmodified hydroxyl groups in CNCs still contribute to the bundling of the nanocrystals. These networks/cages with internally complexed Cu nanoparticles are expected to adhere strongly to the leaf surface and facilitate the controlled release of Cu ions.

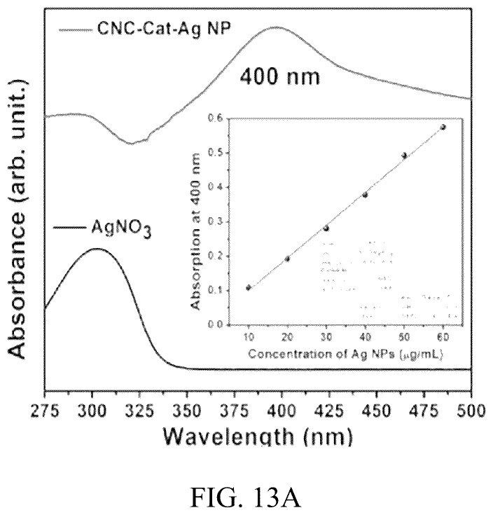

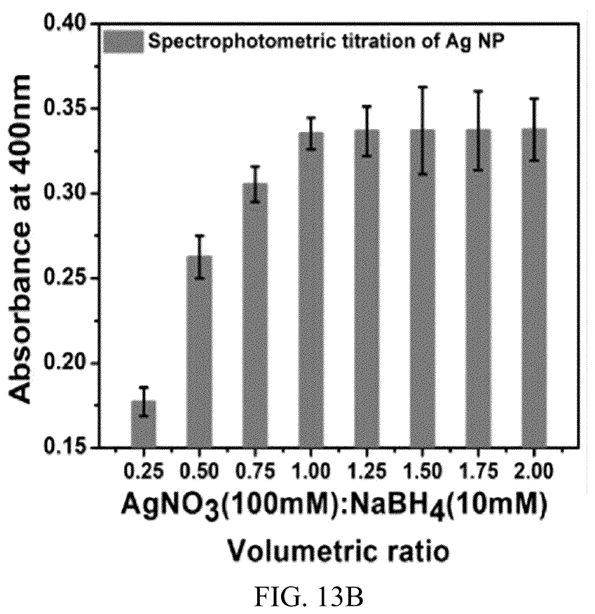

Ag Nanoparticle Formation and Stabilization on Cationized CNCs. Ag nanoparticle formation was validated by UV-Vis spectral analysis (FIG. 13A). UV-Vis spectral scan was performed from 800 to 200 nm on AgNO₃ solution as well as CNC-Cat-Ag NP solution. For CNC-Cat-Ag NP formulation solution, a sharp peak developed at ˜400 nm as a characteristic silver surface plasmon resonance (SPR) peak (392-420 nm range) of Ag NPs. Sharp peak attributed due to uniform and narrow size of Ag NPs. A calibration curve was investigated by dispersing known variable concentrations of Ag NPs in water and evaluating absorbance at 400 nm. The spectrophotometric titration plot was investigated by measuring the NaBH₄ reduction agent required for AgNO₃ solution to form Ag nanoparticles. FIG. 13B shows that NaBH₄ (10 mM): AgNO₃ (100 mM) volume ratio of 1:1 is the highest ratio for forming Ag nanoparticles.

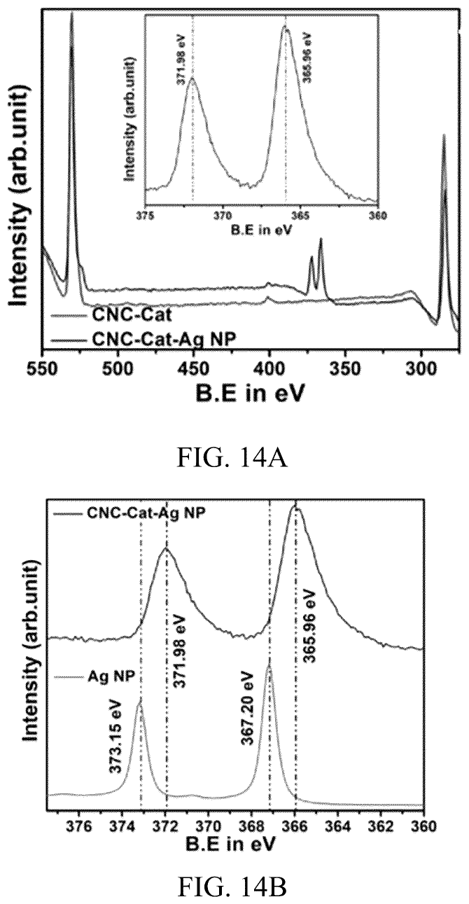

XPS analysis on Ag NP stabilized within cationized CNC (CNC-Cat) powder was performed to understand the state of amine groups after functionalization. From FIG. 14A, it is found that intensity of N1s peak at 401.27 eV reduced slightly after stabilizing with Ag NPs. Two new peaks are developed at 371.98 and 365.96 eV which are attributed due to Ag 3d_{3/2} and Ag 3d_{5/2} band. It is also found that free Ag NPs showed peaks at 373.15 and 367.20 eV for Ag 3d_{3/2} and Ag 3d_{5/2} band (FIG. 14B). This shift of band at lower binding energy signified that Ag NPs were stabilized within CNC structure and size of CNC-cat stabilized Ag NP smaller than Ag NP alone.

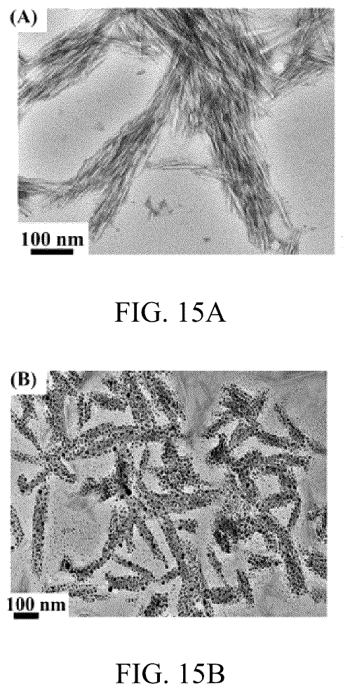

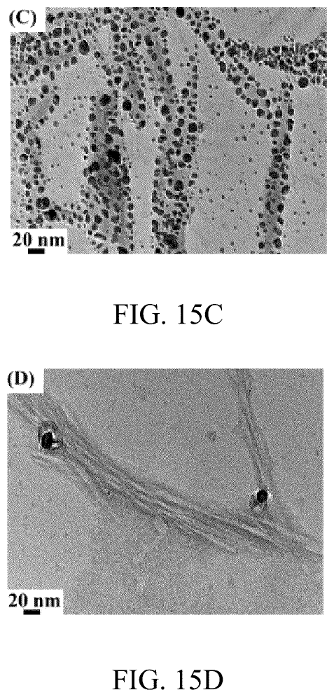

Transmission Electron Microscopy (TEM) Imaging Study to Visualize Ag Nanoparticle Attachment on Cationized CNCs. The decoration of Ag nanoparticles on modified cationized CNCs was studied using TEM imaging (FIGS. 15A-15D). CNCs as a nanocrystal were found to be 100-200 nm long in length and 2-5 nm wide which promoted enhancement in accessibility and attachment of Ag nanoparticles on the surface (FIG. 15A). FIG. 15B-D show that Ag nanoparticles were stabilized by cationized CNCs and decorated along the surface of CNCs. The particle size of these nanoparticles was 5-30 nm and spherical in nature. CNCs were mostly found as bundles, and Ag nanoparticles were decorated along these CNC bundles. The remaining hydroxyl groups after cationization on CNCs were forming these CNC bundle (20-50 nm wide) networks via intra- and intermolecular bonds as well as van der Waals connection between chains. These bundle network decorated Ag nanoparticles can adhere to any surface and promote antibacterial effects.

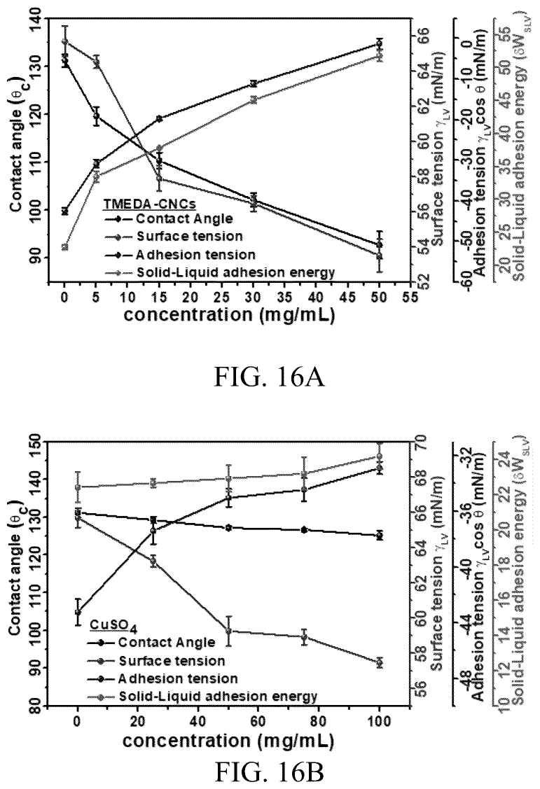

Surface Adhesion Study on Wheat Leaves. Surface adhesion properties of the Cu-TMEDA-CNCs complex solutions were studied by measuring their contact angle and surface tension on wheat leaves. The surface tension of the Cu-TMEDA-CNC dispersed water solution was measured at different contents of CNCs in the solution. As shown in FIG. 16A, the surface tension decreases with the increasing TMEDA-CNC content (65.68±0.86, 64.52±0.37, 57.89±0.72, 56.47±0.46, and 53.52±0.92 mN/m for 0, 5, 15, 30, and 50 mg/mL TMEDA-CNCs in the solution, respectively). The decrease can be ascribed to the higher concentrations of TMEDA-CNCs at the interface between the liquid and air.

The contact angle of the solution also decreases with the increasing TMEDA-CNC concentration (131.2±1.3, 119.62±1.94, 116.35±1.68, 102.14±1.47, and 92.74±2.83° for 0, 5, 15, 30, and 50 mg/mL TMEDA-CNC concentrations, respectively) (FIG. 16A). The large angles show that wheat leaves are superhydrophobic due to the micro/nanoscale needles on the leaf surface. Higher content of TMEDA-CNCs in the droplet promotes interactions between the liquid and the nano/micropillars on the leaf surface, thus lowering the contact angle. High surface tension liquid (e.g., water) assumes the Cassie-Baxter state on a heterogenous surface (e.g., wheat leaf surface), leading to superhydrophobic surface behavior. With a lowered liquid surface tension after adding TMEDA-CNCs into the solution, the droplet tends to transition to the Wenzel state, which decreases the contact angle.

Solid-liquid adhesion energy per unit area (δW_{SLV}) was calculated using equation (11), and the results show that the adhesion energy increases from 22.49±0.08 to 51.82±0.86 mM/m when the TMEDA-CNC concentration increases from 0 to 50 mg/mL (FIG. 16A). CuSO₄ solution was also tested to confirm that the changes in the solution's contact angle, surface tension, and surface adhesion energy were not caused by the chemical. FIG. 16B shows that CuSO₄ alone only causes small fluctuations in the contact angle (from 131.2 to) 125.2°, surface tension (from 65.68 to 57.46 mM/m), and surface adhesion energy (from 22.42 to 24.17 mM/m) when increasing the CuSO₄ concentration from 0 to 100 mg/mL. These results indicate that TMEDA-CNCs promote more interactions between the solutions and the wheat leaf surfaces, increasing the solutions' adhesion to the leaf surfaces.

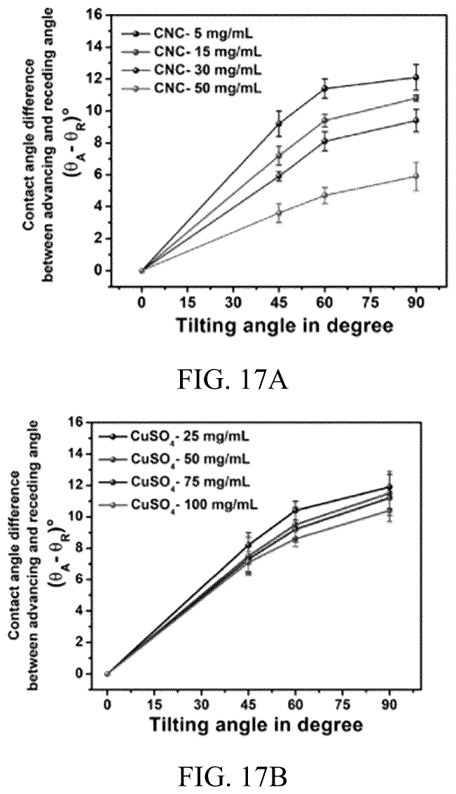

The differences between the advancing contact angle (θ_{A}) and the receding contact angle (θ_{R}) at different leaf tilt angles are shown in FIGS. 17A-17B. At the same tilt angle, the difference decreases with the increasing TMEDA-CNC concentration (FIG. 17A). For instance, at the 90° tilt angle, the difference decreases from ˜12° for the 5 mg/mL solution to ˜6° for the 50 mg/mL one, indicating the improved surface adhesion of the high TMEDA-CNC concentration solution. Similarly, a higher CuSO₄ concentration also leads to a lowered angle difference, but the differences are much smaller, as shown in FIG. 17B, again showing the dominant contribution from TMEDA-CNCs to the improved adhesion of the solution to the leaf surface.

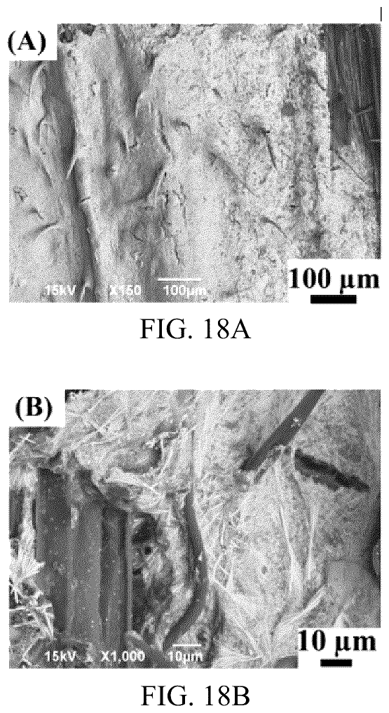

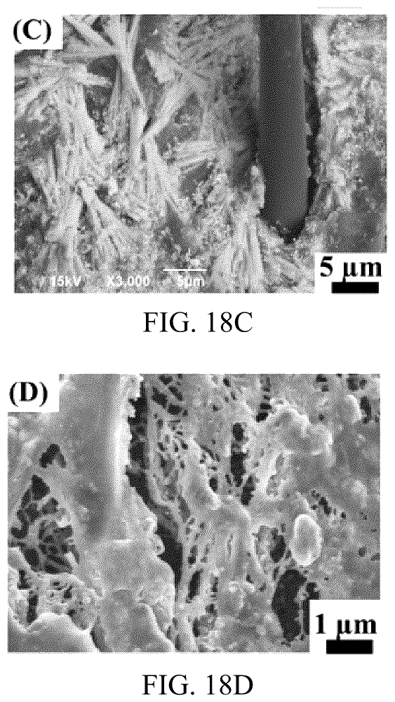

To visually demonstrate the adhesiveness of Cu-TMEDA-CNCs on the surfaces of wheat leaves, SEM and FESEM imaging were conducted. Cu-TMEDA-CNCs are deposited/coated within spikes (FIG. 18A-18C), and the coating survives the washing process used during sample preparation. FESEM imaging further confirms that Cu-TMEDA-CNCs exhibit a network structure on the wheat leaf surface (FIG. 18D).

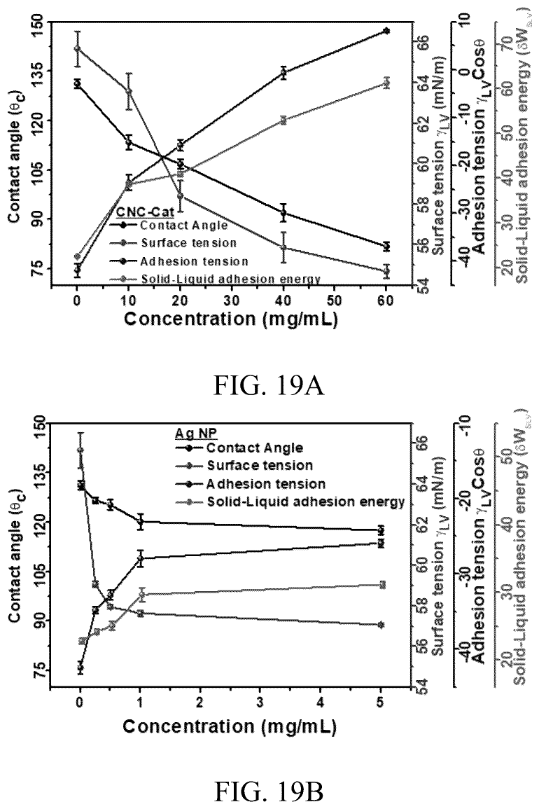

Further, surface adhesion properties of Ag NP were investigated by studying contact angle and surface tension. The surface tension of the CNC-Cat dispersed water solution was evaluated by varying the concentration of CNC-Cat in the formulation. From FIG. 19A surface tension values were found to be 65.68±0.86, 63.57±0.9, 58.40±0.75, 55.87±0.74 and 54.70±0.33 mM/m for 0, 10, 20, 40, and 60 mg/mL concentration of CNC-Cat in the formulation. This finding suggested that surface tension was reduced due to the enhancement of CNC-Cat concentration in the formulation. It was previously reported that surface tension reduced with increasing the concentration of CNC-Cat nanoparticles in the droplet as the CNC-Cat accumulated at the interface between liquid and vapor.

In general, the surface layer of wheat leaves is superhydrophobic in nature due to its micro/nanoscale surface roughness. Water-based suspension of CNC-Cat with variable concentrations (0, 10, 20, 40, and 60 mg/mL) was found to be experienced at contact angles of 131.2±1.3, 113.42±2.26, 106.82±1.47, 92.02±2.78 and 81.82±1.27° on the surface of wheat leaves (FIG. 19A). The result suggested that the elevation in CNC-Cat concentration reduced the contact angle on the superhydrophobic surface. High surface tension liquid such as water experienced the Cassie-Baxter state when dropping on the superhydrophobic surface of wheat leaves and bounced from leaves by forming higher contact angle. Whereas low surface tension liquids experienced the Wenzel state or transition state when dropping on the superhydrophobic surface of wheat leaves and adhering to the leaves' surface by forming relatively low contact angle. Elevation in adhesion tension and solid-liquid adhesion energy per unit area promoted wetting the low surface tension nanoparticle solution on the superhydrophobic leave surface. Solid-liquid adhesion energy per unit area (δW_{SLV}) was calculated based on equation (11) and found that adhesion energy increased from 22.49±0.08 to 61.28±1.2 mM/m with addition of 60 mg/mL CNC-Cat in the solution (FIG. 19A). Whereas, Ag NP suspension alone experienced very small change in contact angle (from 131.2 to) 117.6°, surface tension (from 65.68 to 57.07 mM/m), and surface adhesion energy (from 22.82 to 31.14 mM/m) after increasing the concentration of nanoparticles from 0 to 5 mg/mL (FIG. 19B). This result suggested that CNC-Cat as a bundle nanonetwork promoted more interaction between leaf surface than Ag NP alone and accumulated within the nano/micro pattern of the leaf.

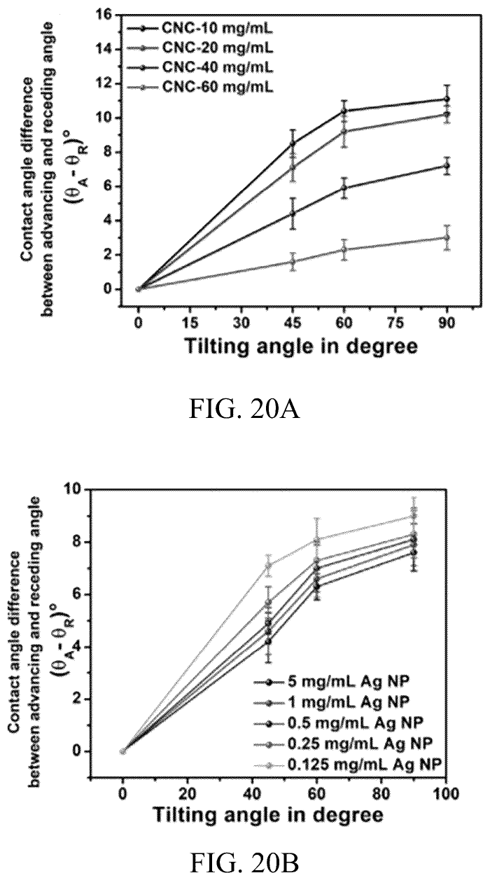

Adhesion Stability of the solution on the leaf surface was measured by tilting the leaf surface at 0°, 45°, 60°, and 90° angles and observing the difference in contact angle between advancing (θ_{A}) and receding contact angle (θ_{R}). The angle difference between advancing (θ_{A}) and receding contact angle (θ_{R}) was evaluated, and it found that a lower concentration of CNC-Cat (10 mg/mL) showed a higher angle difference (˜11°) at 90° tilting angle (FIG. 20A). On the other hand, a higher concentration of CNC-Cat (60 mg/mL) solution experienced a lower angle difference (˜3°) at a 90° tilting angle. Similarly, for Ag NPs droplet alone showed the highest angle difference of) (˜8° at 90° tilting angle with 5 mg/mL concentration and the lowest angle difference of (˜10°) at 90° tilting angle with 0.125 mg/mL concentration (FIG. 20B). This result demonstrated that formulation with higher content of CNC-Cat adhered on the wheat plant leaf surface even at 90° tilting angle, and droplets did not change their angle due to gravitation pull.

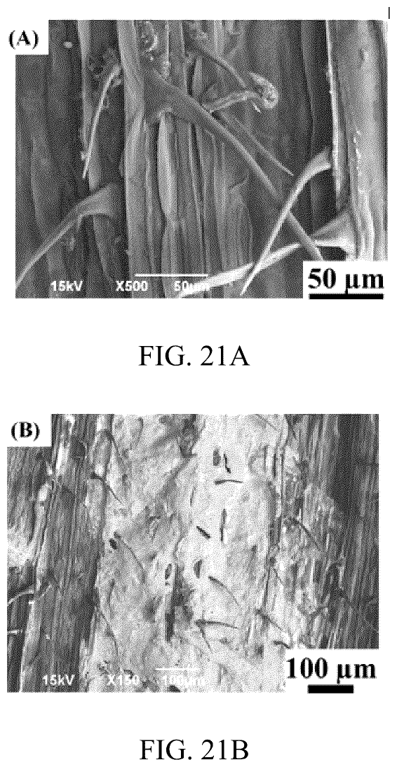

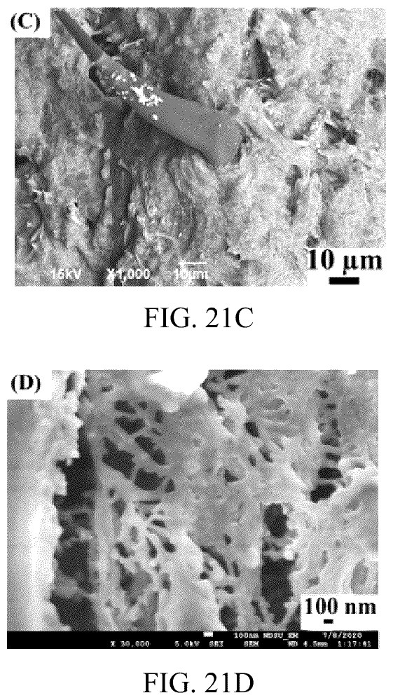

To visualize the surface stickiness of CNC-Cat-Ag NPs on wheat leaves, SEM and FESEM imaging was carried out. It was found that plant leaves have micron-size spikes (FIG. 21A), and CNC-Cat-Ag NPs were deposited/coated within spikes (FIG. 21B-21C). However, even after water-based washing, it did not remove the CNC-Cat-Ag NPs network structure within leaf spikes. FESEM imaging further showed that CNC-Cat-Ag NPs formed a network structure on the surface of the wheat leaf (FIG. 21D).

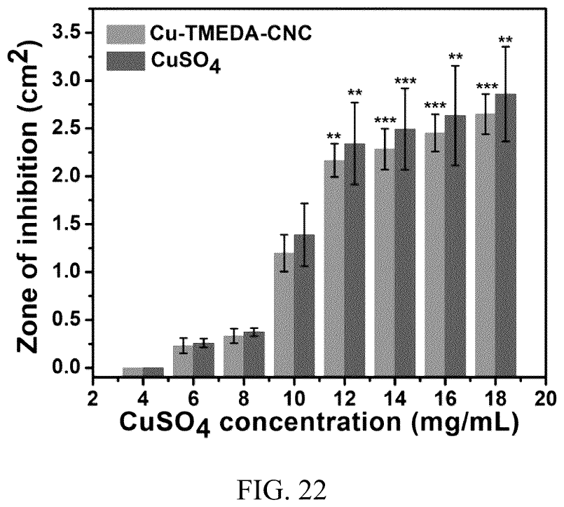

Antibacterial Properties of Cu-TMEDA-CNCs and CNC-Cat-Ag NPs on Xanthomonas translucens pv. undulosa. Antibacterial properties of both CuSO₄ and Cu-TMEDA-CNCs formulation were investigated on Xanthomonas translucens pv. undulosa. After 2 days of treatment, both formulations show similar antibacterial effects (FIG. 22). CuSO₄ exhibits an inhibition zone of ˜2.86 cm² area at 18 mg/mL concentration, whereas Cu-TMEDA-CNCs show a ˜2.65 cm² inhibition zone at the same concentration. Pristine CNCs and TMEDA-CNC (without Cu) show no zone of inhibition, as expected. Although both CuSO₄ and Cu-TMEDA-CNCs demonstrate similar antibacterial effects due to the presence of the same concentration of Cu, Cu-TMEDA-CNCs have the advantage of stronger leaf adhesion as shown earlier, and are more resistant to the environment. The CNC network structure constrains the Cu nanoparticles in the complex and only releases Cu ions in a controlled manner.

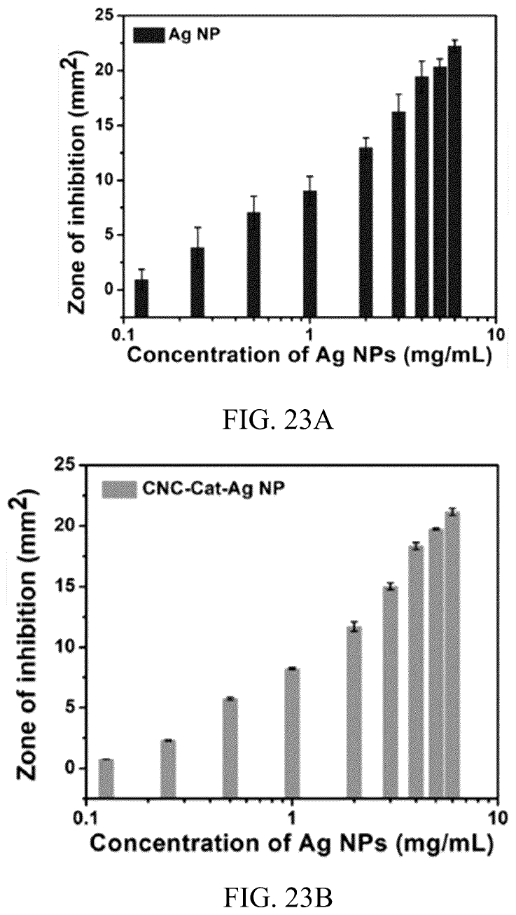

Similarly, the antibacterial properties of both unstabilized Ag NPs and CNC-Cat stabilized Ag NPs (same Ag NP concentration on both formulations) were studied on Xanthomonas translucens pv. undulosa. After 2 days of treatment, it was found that both formulations showed similar levels of antibacterial properties (FIGS. 23A-23B). Commercially available Ag NP developed an inhibition zone of ˜0.2033 mm² area with 5 mg/mL Ag concentration (FIG. 23A). In comparison, the CNC-Cat-Ag NP formulation developed an inhibition zone of ˜0.1974 cm² area with 5 mg/mL Ag concentration (FIG. 23B). Pristine CNC and CNC-Cat formulations without Ag NP stabilized products were also investigated to observe as a controlled study. There were no zones of inhibition developed with pristine CNC and CNC-Cat formulation. However, both unconjugated and conjugated formulations showed similar antibacterial effects due to the presence of the same concentration of Ag NPs. In addition, these stabilized Ag NPs showed good adhesion properties, and conjugated Ag NPs would not wash away from nanostructures.

Greenhouse Study on Wheat Plants with CNC Stabilized Ag Nanoparticle.

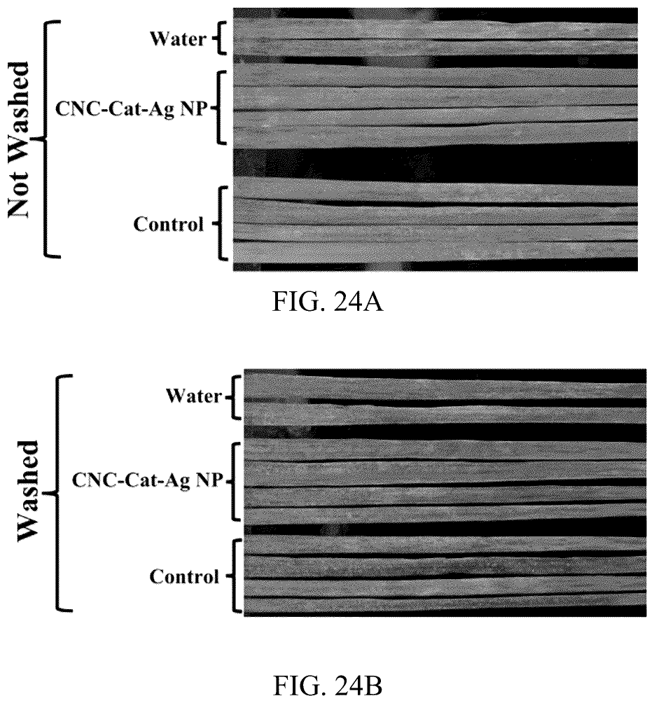

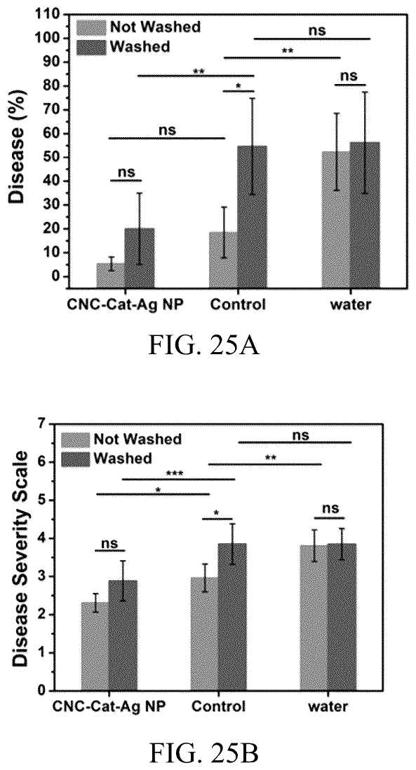

The greenhouse study was conducted with CNC-Cat-Ag-NPs sample formulation and control formulation (mixture of pristine CNC and commercially available Ag NPs). In the case of unwashed plants, water as control was not protected and showed the highest bacterial leaf streak (FIG. 24A). Wheat leaves applied with CNC-Cat-Ag-NPs sample formulation led to minimal to no bacterial leaf streak (FIG. 24A), whereas a mixture of pristine CNC and commercially available Ag NPs as a control showed slightly higher bacterial leaf streak (FIG. 24A). One of the significant drawbacks of the unconjugated formulation was that Ag NPs were not bounded within CNCs and got separated from each other easily. Even within an hour, Ag NPs precipitated from unconjugated formulation, whereas CNC-Cat-Ag-NPs liquid sample formulation remained stable for months. In the case of washed plants, water as control and mixture as control (combination of pristine CNC and commercially available Ag NPs) showed a severe case of bacterial leaf streak (FIG. 24B). Whereas wheat leaves applied with CNC-Cat-Ag-NPs sample formulation showed minimal signs of bacterial leaf streak (FIG. 24B). This was reported in FIG. 25A-25B after calculating the disease percentage and severity level. FIG. 25A shows that CNC-Cat-Ag NPs formulation treated wheat plant showed 5.38±2.87 and 20±14.93 disease % for unwashed and washed plants, whereas a mixture of pristine CNC and commercially available Ag NPs treated wheat plants showed 18.46±10.63 and 54.61±20.23 disease % for unwashed and washed plants. Lastly, just water application showed 52.31±16.24 and 56.15±21.32 disease % for unwashed and washed plants. The level of disease severity (out of 5 scales) was also evaluated and reported in FIG. 25B. It is reported that CNC-Cat-Ag NPs formulation-treated wheat plants experienced 2.31±0.24 and 2.88±0.52 levels of disease severity for unwashed and washed plants. Whereas a mixture of pristine CNC and commercially available Ag NPs treated wheat plants developed 2.96±0.36 and 3.85±0.53 levels of disease severity for unwashed and washed plants. Lastly, just water application showed 3.81±0.42 and 3.85±0.41 levels of disease severity for unwashed and washed plants. This greenhouse study concluded that CNC-Cat-Ag NPs showed the best performance in the case of disease control even after washed stages.

Greenhouse Study on Wheat Plants with CNC-TMEDA-Cu Nanoparticles

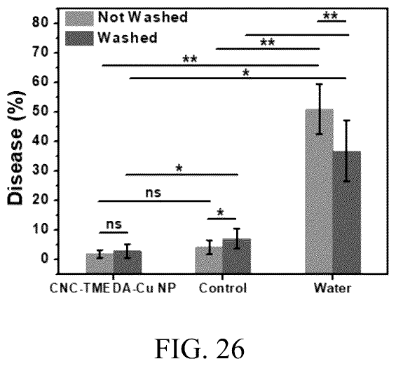

The greenhouse study was conducted with CNC-TMEDA-Cu NPs sample formulation, control formulation (mixture of pristine CNC and commercially available CuSO₄), and water. As shown in FIG. 26, it was found that the CNC-TMEDA-Cu NPs formulation treated wheat plants showed 1.87±1.33 and 2.77±2.33 disease percentage for unwashed and washed plants. The mixture of pristine CNC and commercially available CuSO₄-treated wheat plants showed 4.07±2.39 and 7±3.34 disease percentage for unwashed and washed plants. Lastly, water application alone showed 50.75±8.52 and 36.62±10.31 disease percentage for unwashed and washed plants. In the case of washed or unwashed plants, water did not show any protection and showed the highest bacterial leaf streak. Wheat leaves applied with the CNC-TMEDA-Cu NPs sample formulation showed minimal to no bacterial leaf streak. Whereas a mixture of pristine CNC and commercially available CuSO₄ as a control showed slightly elevated bacterial leaf streak. One of the significant drawbacks of unconjugated formulation was that CuSO₄ was not bound within CNC and got separated from them easily. In the case of washed plants, control (mixture of pristine CNC and commercially available CuSO₄) showed a slight increase in disease percentage. In contrast, wheat leaves with the CNC-TMEDA-Cu NPs sample formulation applied showed minimal signs of bacterial leaf streak, even after washing the plants. This field study concluded that CNC-TMEDA-Cu NPs showed the best performance in the case of disease control, even after washing stages.

### DISCUSSION

Cu nanoparticles were successfully complexed with the TMEDA-CNCs system through tosylation and TMEDA functionalization of CNCs. UV-Vis and XPS analyses and TEM investigation confirmed the complexation. The Cu-TMEDA-CNCs complex demonstrated strong antibacterial activity against Xanthomonas translucens pv. undulosa pathogen. TMEDA-CNC showed good surface adhesion to the wheat leaf surfaces, which prolonged its duration on the surface. The Cu ions released gradually from the complexed Cu nanoparticles enable strong, long-lasting antibacterial activities of the complex without requiring repeated application and the risk of chemical runoff. Furthermore, an Ag NP decorated CNC network was successfully designed. To stabilize the Ag NPs on the surface of CNCs, cationization modification was successfully performed by investigating the DMSO, water, and GTMAC ratios. High surface charge was achieved from GTMAC and (DI water: DMSO=1:1) total system ratio of (1:1) solvent system. The highest surface-charged formulation was used for stabilizing Ag NPs. After reduction from AgNO₃ ionic solution by NaBH₄ reducing agents, Ag ions stabilized their charge with a quaternary amine of cationized CNCs (CNC-Cat) and produced nascent zero (0) valent Ag NPs. From TEM analysis, it is reported that Ag NPs were successfully developed and decorated on the surface of CNCs as a conjugate form. Cationized CNCs showed high adhesive properties toward plant leaves based on the contact angle, surface tension, and surface adhesion energy study. Antibacterial study on Xanthomonas translucens pv. undulosa pathogen was performed with CNC-Cat-Ag NPs formulation and demonstrated effective antibacterial properties. A greenhouse study was conducted to investigate the importance of using conjugated Ag NPs rather than unconjugated products, and the result showed that conjugated Ag NPs showed the highest protection even after washing the wheat plants for replicating environmental washing effects. Conjugated, stabilized CNC-Cat-Ag NPs formulation showed no precipitation and remained stable for months. A greenhouse study was also conducted to investigate the importance of using conjugated Cu NPs rather than unconjugated products, and the results showed that conjugated Cu NPs showed the highest protection even after washing the wheat plants for replicating environmental washing effects.

To conclude, we have explored biobased, biodegradable, natural polymers with stabilized metal nanoparticles in its structure that can be utilized to reduce soil and/or water pollution by reducing the number of treatments on wheat plants. The newly developed cellulose nano-networks with stabilized metal nanoparticles can be implemented to adhere to a plant surface over an extended period of time, thereby allowing gradual and prolonged delivery of antibacterial metal ions and offering defense against bacterial/fungal infection. As a result of such prolonged delivery, fewer fungicide/bactericide applications would be required, thereby improving economic results and enabling cost-effective management of BLS infection.

### REFERENCES

All publications, patents, and patent applications mentioned in this specification are herein incorporated by reference to the same extent as if each individual publication, patent, or patent application was specifically and individually indicated to be incorporated by reference, including the references set forth in the following list:
1. Sapkota, S.; Mergoum, M.; Liu, Z., The translucens group of Xanthomonas translucens: Complicated and important pathogens causing bacterial leaf streak on cereals. Molecular Plant Pathology 2020, 21 (3), 291-302.
2. Bamberg, R. H., Black chaff disease of wheat. J. Agric. Res 1936, 52, 397-417.
3. Duveiller, E., Seed detection of Xanthomonas campestris pv. undulosa using a modification of Wilbrink's agar medium. Parasitica 1990, 46 (1), 3-17.
4. Duveiller, E., The bacterial diseases of wheat: concepts and methods of disease management. CIMMYT: 1997.
5. Milus, E.; Mirlohi, A., Use of disease reactions to identify resistance in wheat to bacterial streak. Plant disease 1994, 78 (2), 157-161.
6. Tubajika, K.; Russin, J.; Harrison, S., Analysis of bacterial leaf streak epidemics on winter wheat in Louisiana. Plant disease 1999, 83 (6), 541-548.
7. Adhikari, T. B.; Gurung, S.; Hansen, J. M.; Bonman, J. M., Pathogenic and Genetic Diversity of Xanthomonas translucens pv. undulosa in North Dakota. Phytopathology® 2012, 102 (4), 390-402.
8. Kandel, Y. R.; Glover, K. D.; Tande, C. A.; Osborne, L. E., Evaluation of spring wheat germplasm for resistance to bacterial leaf streak caused by Xanthomonas campestris pv. translucens. Plant Disease 2012, 96 (12), 1743-1748.
9. Curland, R. D.; Gao, L.; Bull, C. T.; Vinatzer, B. A.; Dill-Macky, R.; Van Eck, L.; Ishimaru, C. A., Genetic diversity and virulence of wheat and barley strains of Xanthomonas translucens from the Upper Midwestern United States., 2018, Phytopathology, 108 (4), 443-453.
10. Waldron, L., The relationship of black chaff disease of wheat to certain physical and pathological characters. Science 1929, 70 (1811), 268-268.
11. Forster, R.; Schaad, N., Control of black chaff of wheat with seed treatment and a foundation seed health program. Plant Disease 1988, 72 (11), 935-938.
12. Tubajika, K.; Tillman, B.; Russin, J.; Clark, C.; Harrison, S., Relationship between flag leaf symptoms caused by Xanthomonas translucens pv. translucens and subsequent seed transmission in wheat. Plant disease 1998, 82 (12), 1341-1344.
13. Shane, W.; Baumer, J.; Teng, P., Crop losses caused by Xanthomonas streak on spring wheat and barley. Plant disease 1987, 71 (10), 927-930.
14. Vauterin, L.; Yang, P.; Hoste, B.; Pot, B.; Swings, J.; Kersters, K., Taxonomy of xanthomonads from cereals and grasses based on SDS-PAGE of proteins, fatty acid analysis and DNA hybridization. Microbiology 1992, 138 (7), 1467-1477.
15. Vauterin, L.; Hoste, B.; Kersters, K.; Swings, J., Reclassification of Xanthomonas. International Journal of Systematic and Evolutionary Microbiology 1995, 45 (3), 472-489.
16. Peng, Z.; Hu, Y.; Xie, J.; Potnis, N.; Akhunova, A.; Jones, J.; Liu, Z.; White, F. F.; Liu, S., Long read and single molecule DNA sequencing simplifies genome assembly and TAL effector gene analysis of Xanthomonas translucens. BMC genomics 2016, 17 (1), 1-19.
17. Langlois, P. A.; Snelling, J.; Hamilton, J. P.; Bragard, C.; Koebnik, R.; Verdier, V.; Triplett, L. R.; Blom, J.; Tisserat, N. A.; Leach, J. E., Characterization of the Xanthomonas translucens complex using draft genomes, comparative genomics, phylogenetic analysis, and diagnostic LAMP assays. Phytopathology 2017, 107 (5), 519-527.
18. Hersemann, L.; Wibberg, D.; Blom, J.; Goesmann, A.; Widmer, F.; Vorhölter, F.-J.; Kölliker, R., Comparative genomics of host adaptive traits in Xanthomonas translucens pv. graminis. BMC genomics 2017, 18 (1), 1-18.
19. Bragard, C.; Verdier, V.; Maraite, H., Genetic diversity among Xanthomonas campestris strains pathogenic for small grains. Applied and environmental microbiology 1995, 61 (3), 1020-1026.
20. Bragard, C.; Singer, E.; Alizadeh, A.; Vauterin, L.; Maraite, H.; Swings, J., Xanthomonas translucens from small grains: diversity and phytopathological relevance. Phytopathology 1997, 87 (11), 1111-1117.
21. Worrall, E. A.; Hamid, A.; Mody, K. T.; Mitter, N.; Pappu, H. R., Nanotechnology for plant disease management. Agronomy 2018, 8 (12), 285.
22. Singh, J.; Vishwakarma, K.; Ramawat, N.; Rai, P.; Singh, V. K.; Mishra, R. K.; Kumar, V.; Tripathi, D. K.; Sharma, S., Nanomaterials and microbes' interactions: a contemporary overview. 3 Biotech 2019, 9 (3), 1-14.
23. Zhang, L.; Ding, Y.; Povey, M.; York, D., ZnO nanofluids-A potential antibacterial agent. Progress in Natural Science 2008, 18 (8), 939-944.
24. Zhang, L.; Jiang, Y.; Ding, Y.; Povey, M.; York, D., Investigation into the antibacterial behaviour of suspensions of ZnO nanoparticles (ZnO nanofluids). Journal of Nanoparticle Research 2007, 9 (3), 479-489.
25. Hangamaisho, A. Efficacy of Nanomaterials and Biorationals on the Bacterial Leaf Streak Management in Wheat. South Dakota State University 2022.
26. Radzig, M.; Nadtochenko, V.; Koksharova, O.; Kiwi, J.; Lipasova, V.; Khmel, I., Antibacterial effects of silver nanoparticles on gram-negative bacteria: influence on the growth and biofilms formation, mechanisms of action. Colloids and Surfaces B: Biointerfaces 2013, 102, 300-306.
27. Rai, M.; Ingle, A. P.; Paralikar, P.; Anasane, N.; Gade, R.; Ingle, P., Effective management of soft rot of ginger caused by Pythium spp. and Fusarium spp.: emerging role of nanotechnology. Applied microbiology and biotechnology 2018, 102 (16), 6827-6839.
28. Choudhury, S.; Panda, P.; Sahoo, L.; Panda, S. K., Reactive oxygen species signaling in plants under abiotic stress. Plant signaling & behavior 2013, 8 (4), e23681.
29. Suresh, A. K.; Pelletier, D. A.; Doktycz, M. J., Relating nanomaterial properties and microbial toxicity. Nanoscale 2013, 5 (2), 463-474.
30. Liao, Y.-Y.; Strayer-Scherer, A.; White, J.; Mukherjee, A.; De La Torre-Roche, R.; Ritchie, L.; Colee, J.; Vallad, G.; Freeman, J.; Jones, J., Nano-magnesium oxide: A novel bactericide against copper-tolerant Xanthomonas perforans causing tomato bacterial spot. Phytopathology 2019, 109 (1), 52-62.
31. Limongi, T.; Canta, M.; Racca, L.; Ancona, A.; Tritta, S.; Vighetto, V.; Cauda, V., Improving dispersal of therapeutic nanoparticles in the human body. Nanomedicine 2019, 14 (7), 797-801.
32. Manojkumar, K.; Sivaramakrishna, A.; Vijayakrishna, K., A short review on stable metal nanoparticles using ionic liquids, supported ionic liquids, and poly (ionic liquids). Journal of Nanoparticle Research 2016, 18 (4), 1-22.
33. Phan, H. T.; Haes, A. J., What does nanoparticle stability mean? The Journal of Physical Chemistry C 2019, 123 (27), 16495-16507.
34. Kamiya, H.; Iijima, M., Surface modification and characterization for dispersion stability of inorganic nanometer-scaled particles in liquid media. Science and Technology of Advanced Materials 2010.
35. Beckers, S. J.; Wetherbee, L.; Fischer, J.; Wurm, F. R., Fungicide-loaded and biodegradable xylan-based nanocarriers. Biopolymers 2020, 111 (12), e23413.
36. Wanner, P., Plastic in agricultural soils-A global risk for groundwater systems and drinking water supplies?—A review. Chemosphere 2021, 264, 128453.
37. Incani, V.; Danumah, C.; Boluk, Y., Nanocomposites of nanocrystalline cellulose for enzyme immobilization. Cellulose 2013, 20, 191-200.
38. Hazra, R. S.; Hasan Khan, M. R.; Kale, N.; Tanha, T.; Khandare, J.; Ganai, S.; Quadir, M., Bioinspired Materials for Wearable Devices and Point-of-Care Testing of Cancer. ACS Biomaterials Science & Engineering 2022.
39. Hazra, R. S.; Kale, N.; Aland, G.; Qayyumi, B.; Mitra, D.; Jiang, L.; Bajwa, D.; Khandare, J.; Chaturvedi, P.; Quadir, M., Cellulose Mediated Transferrin Nanocages for Enumeration of Circulating Tumor Cells for Head and Neck Cancer. Scientific Reports 2020, 10 (1), 10010.
40. Hazra, R. S.; Dutta, D.; Mamnoon, B.; Nair, G.; Knight, A.; Mallik, S.; Ganai, S.; Reindl, K.; Jiang, L.; Quadir, M., Polymeric Composite Matrix with High Biobased Content as Pharmaceutically Relevant Molecular Encapsulation and Release Platform. ACS Applied Materials & Interfaces 2021, 13 (34), 40229-40248.
41. Rakib Hasan Khan, M.; Hazra, R. S.; Nair, G.; Mohammad, J.; Jiang, L.; Reindl, K.; Khalid Jawed, M.; Ganai, S.; Quadir, M., Cellulose Nanofibers as Scaffold-forming Materials for Thin Film Drug Delivery Systems. International Journal of Pharmaceutics 2022, 122189.
42. Khattab, M. M.; Abdel-Hady, N. A.; Dahman, Y., 21—Cellulose nanocomposites: Opportunities, challenges, and applications. In Cellulose-Reinforced Nanofibre Composites, Jawaid, M.; Boufi, S.; H. P. S, A. K., Eds. Woodhead Publishing: 2017; pp 483-516.
43. Picheth, G. F.; Pirich, C. L.; Sierakowski, M. R.; Woehl, M. A.; Sakakibara, C. N.; de Souza, C. F.; Martin, A. A.; da Silva, R.; de Freitas, R. A., Bacterial cellulose in biomedical applications: A review. International Journal of Biological Macromolecules 2017, 104, 97-106.
44. Bhat, A. H.; Khan, I.; Usmani, M. A.; Umapathi, R.; A1-Kindy, S. M. Z., Cellulose an ageless renewable green nanomaterial for medical applications: An overview of ionic liquids in extraction, separation and dissolution of cellulose. International Journal of Biological Macromolecules 2019, 129, 750-777.
45. Seddiqi, H.; Oliaei, E.; Honarkar, H.; Jin, J.; Geonzon, L. C.; Bacabac, R. G.; Klein-Nulend, J., Cellulose and its derivatives: towards biomedical applications. Cellulose 2021, 28 (4), 1893-1931.
46. Mariano, M.; El Kissi, N.; Dufresne, A., Cellulose nanocrystals and related nanocomposites: Review of some properties and challenges. Journal of Polymer Science Part B: Polymer Physics 2014, 52 (12), 791-806.
47. Farooq, A.; Patoary, M. K.; Zhang, M.; Mussana, H.; Li, M.; Naeem, M. A.; Mushtaq, M.; Farooq, A.; Liu, L., Cellulose from sources to nanocellulose and an overview of synthesis and properties of nanocellulose/zinc oxide nanocomposite materials. International journal of biological macromolecules 2020, 154, 1050-1073.
48. Oun, A. A.; Shankar, S.; Rhim, J.-W., Multifunctional nanocellulose/metal and metal oxide nanoparticle hybrid nanomaterials. Critical reviews in food science and nutrition 2020, 60 (3), 435-460.
49. Jia, R.; Tian, W.; Bai, H.; Zhang, J.; Wang, S.; Zhang, J., Amine-responsive cellulose-based ratiometric fluorescent materials for real-time and visual detection of shrimp and crab freshness. Nature Communications 2019, 10 (1), 1-8.
50. Rose, M.; Palkovits, R., Cellulose-based sustainable polymers: state of the art and future trends. Macromol Rapid Commun 2011, 32 (17), 1299-311.
51. George, J.; Sabapathi, S. N., Cellulose nanocrystals: synthesis, functional properties, and applications. Nanotechnol Sci Appl 2015, 8, 45-54.
52. Liang, L.; Bhagia, S.; Li, M.; Huang, C.; Ragauskas, A. J., Cross-Linked Nanocellulosic Materials and Their Applications. ChemSusChem 2020, 13 (1), 78-87.
53. Zaman, M.; Xiao, H.; Chibante, F.; Ni, Y., Synthesis and characterization of cationically modified nanocrystalline cellulose. Carbohydrate Polymers 2012, 89 (1), 163-170.
54. Sarker, N. C.; Ray, P.; Pfau, C.; Kalavacharla, V.; Hossain, K.; Quadir, M., Development of Functional Nanomaterials from Wheat Bran Derived Arabinoxylan for Nucleic Acid Delivery. Journal of Agricultural and Food Chemistry 2020, 68 (15), 4367-4373.
55. Postek, M. T.; Moon, R. J.; Rudie, A. W.; Bilodeau, M. A. Production and Applications of Cellulose Nanomaterials. Tappi Press 2013, Order Number: 0101R332; ISBN: 978-1-59510-224-9.
56. Sadeghifar, H.; Filpponen, I.; Clarke, S. P.; Brougham, D. F.; Argyropoulos, D. S., Production of cellulose nanocrystals using hydrobromic acid and click reactions on their surface. Journal of Materials Science 2011, 46 (22), 7344-7355.
57. Liebert, T.; Hänsch, C.; Heinze, T., Click Chemistry with Polysaccharides. Macromolecular Rapid Communications 2006, 27 (3), 208-213.
58. Zhang, J.; Xu, X.-D.; Wu, D.-Q.; Zhang, X.-Z.; Zhuo, R.-X., Synthesis of thermosensitive P (NIPAAm-co-HEMA)/cellulose hydrogels via “click” chemistry. Carbohydrate Polymers 2009, 77 (3), 583-589.
59. Heinze, T.; Liebert, T., Unconventional methods in cellulose functionalization. Progress in Polymer Science 2001, 26 (9), 1689-1762.
60. Schrader, M. E., Young-Dupre Revisited. Langmuir 1995, 11 (9), 3585-3589.
61. Nakata, N.; Kakimoto, M.; Nishita, T., Animation of Water Droplets on a Hydrophobic Windshield. 2012.
62. Adhikari, T. B.; Hansen, J. M.; Gurung, S.; Bonman, J. M., Identification of New Sources of Resistance in Winter Wheat to Multiple Strains of Xanthomonas translucens pv. undulosa. Plant Disease 2011, 95 (5), 582-588.
63. Duveiller, E.; van Ginkel, M.; Thijssen, M., Genetic analysis of resistance to bacterial leaf streak caused by Xanthomonas campestris pv. undulosa in bread wheat. Euphytica 1992, 66 (1), 35-43.
64. Rahn, K.; Diamantoglou, M.; Klemm, D.; Berghmans, H.; Heinze, T., Homogeneous synthesis of cellulose p-toluenesulfonates in N,N-dimethylacetamide/LiCl solvent system. Die Angewandte Makromolekulare Chemie 1996, 238 (1), 143-163.
65. Guo, W.; Leu, W.-T.; Hsiao, S.-H., Synthesis and properties of ortho-linked aromatic poly-(ester-amide) s and poly-(ester-imide) s bearing 2,3-bis-(benzoyloxy)-naphthalene units. Journal of Polymer Research 2007, 14 (5), 359-372.
66. Elchinger, P.-H.; Faugeras, P.-A.; Zerrouki, C.; Montplaisir, D.; Brouillette, F.; Zerrouki, R., Tosylcellulose synthesis in aqueous medium. Green Chemistry 2012, 14 (11), 3126-3131.
67. Zhang, K.; Lam, K.-F.; Albela, B.; Xue, T.; Khrouz, L.; Hou, Q.-W.; Yuan, E.-H.; He, M.-Y.; Bonneviot, L., Mononuclear-Dinuclear Equilibrium of Grafted Copper Complexes Confined in the Nanochannels of MCM-41 Silica. Chemistry—A European Journal 2011, 17 (50), 14258-14266.
68. Artyushkova, K., Misconceptions in interpretation of nitrogen chemistry from x-ray photoelectron spectra. Journal of Vacuum Science &amp; Technology A 2020, 38 (3), 031002.
69. Prathapan, R.; Thapa, R.; Garnier, G.; Tabor, R. F., Modulating the zeta potential of cellulose nanocrystals using salts and surfactants. Colloids and Surfaces A: Physicochemical and Engineering Aspects 2016, 509, 11-18.
70. Khalil, M. I.; Beliakova, M. K.; Aly, A. A., Preparation of some starch ethers using the semi-dry state process. Carbohydrate Polymers 2001, 46 (3), 217-226.
71. Pi-xin, W.; Xiu-li, W.; Xue, D.-h.; Xu, K.; Tan, Y.; Du, X.-b.; Li, W.-b., Preparation and characterization of cationic corn starch with a high degree of substitution in dioxane-THF-water media. Carbohydrate Research 2009, 344 (7), 851-855.
72. Bendoraitiene, J.; Kavaliauskaite, R.; Klimaviciute, R.; Zemaitaitis, A., Peculiarities of Starch Cationization with Glycidyltrimethylammonium Chloride. Starch-Stärke 2006, 58 (12), 623-631.
73. Ren, J. L.; Sun, R. C.; Liu, C. F.; Chao, Z. Y.; Luo, W., Two-step preparation and thermal characterization of cationic 2-hydroxypropyltrimethylammonium chloride hemicellulose polymers from sugarcane bagasse. Polymer Degradation and Stability 2006, 91 (11), 2579-2587.
74. Kačuráková, M.; Ebringerová, A.; Hirsch, J.; Hromádková, Z., Infrared study of arabinoxylans. Journal of the Science of Food and Agriculture 1994, 66 (3), 423-427.
75. Ravi, S.; Zhang, S.; Lee, Y.-R.; Kang, K.-K.; Kim, J.-M.; Ahn, J.-W.; Ahn, W.-S., EDTA-functionalized KCC-1 and KIT-6 mesoporous silicas for Nd3+ ion recovery from aqueous solutions. Journal of Industrial and Engineering Chemistry 2018, 67, 210-218.
76. Xue, F.; He, H.; Zhu, H.; Huang, H.; Wu, Q.; Wang, S., Structural Design of a Cellulose-Based Solid Amine Adsorbent for the Complete Removal and Colorimetric Detection of Cr (VI). Langmuir 2019, 35 (39), 12636-12646.
77. Saleemh, F. A.; Musameh, S.; Sawafta, A.; Brandao, P.; Tavares, C. J.; Ferdov, S.; Barakat, A.; Ali, A. A.; Al-Noaimi, M.; Warad, I., Diethylenetriamine/diamines/copper (II) complexes [Cu(dien)(NN)]Br2: Synthesis, solvatochromism, thermal, electrochemistry, single crystal, Hirshfeld surface analysis and antibacterial activity. Arabian Journal of Chemistry 2017, 10 (6), 845-854.
78. Champouret, Y.; Gulli, S.; Daran, J.-C.; Poli, R., Preparation of Diamine-β-diketiminato Copper (II) Complexes and Their Application in the Reverse Atom-Transfer Radical Polymerization of Styrene. European Journal of Inorganic Chemistry 2012, 2012 (10), 1672-1679.
79. Leloup, J.; Ruaudel-Teixier, A.; Barraud, A.; Roulet, H.; Dufour, G., XPS study of copper sulphides inserted into a Langmuir-Blodgett matrix. Applied Surface Science 1993, 68 (2), 231-242.
80. Baruah, B.; Gabriel, G. J.; Akbashev, M. J.; Booher, M. E., Facile Synthesis of Silver Nanoparticles Stabilized by Cationic Polynorbornenes and Their Catalytic Activity in 4-Nitrophenol Reduction. Langmuir 2013, 29 (13), 4225-4234.
81. Logaranjan, K.; Raiza, A. J.; Gopinath, S. C. B.; Chen, Y.; Pandian, K., Shape- and Size-Controlled Synthesis of Silver Nanoparticles Using Aloe vera Plant Extract and Their Antimicrobial Activity. Nanoscale Research Letters 2016, 11 (1), 520.
82. Pucelik, B.; Sułek, A.; Borkowski, M.; Barzowska, A.; Kobielusz, M.; Dąbrowski, J. M., Synthesis and Characterization of Size- and Charge-Tunable Silver Nanoparticles for Selective Anticancer and Antibacterial Treatment. ACS Applied Materials & Interfaces 2022, 14 (13), 14981-14996.
83. Schnippering, M.; Carrara, M.; Foelske, A.; Kötz, R.; Fermín, D. J., Electronic properties of Ag nanoparticle arrays. A Kelvin probe and high resolution XPS study. Phys. Chem. Chem. Phys. 2007, 9 (6), 725-730.
84. Gençer, A.; Schütz, C.; Thielemans, W., Influence of the Particle Concentration and Marangoni Flow on the Formation of Cellulose Nanocrystal Films. Langmuir 2017, 33 (1), 228-234.
85. Sunita, T.; Sharma, P.; Malviya, R., Influence of Concentration on Surface Tension &amp; Viscosity of Tamarind (Tamarindus Indica) Seed Gum. Annals of Molecular and Genetic Medicine 2017, 1 (1), 008-012.
86. Park, H.; Kim, S.; Gruszewski, H. A.; Schmale, D. G.; Boreyko, J. B.; Jung, S., Dynamics of splashed droplets impacting wheat leaves treated with a fungicide. Journal of The Royal Society Interface 2020, 17 (168), 20200337.
87. Stosch, A. K.; Solga, A.; Steiner, U.; Oerke, E. C.; Barthlott, W.; Cermann, Z., Efficiency of self-cleaning properties in wheat (Triticum aestivum L.). Journal of applied botany and food quality 2012.
88. Jothi Prakash, C. G.; Prasanth, R., Approaches to design a surface with tunable wettability: a review on surface properties. Journal of Materials Science 2021, 56 (1), 108-135.
89. Kim, S.; Park, H.; Gruszewski, H. A.; Schmale, D. G.; Jung, S., Vortex-induced dispersal of a plant pathogen by raindrop impact. Proceedings of the National Academy of Sciences 2019, 116 (11), 4917-4922.
90. Shino, C.; Okumura, K.; Quéré, D., Wetting transitions on rough surfaces. Europhys. Lett. 2004, 68, 419-425.
91. Reyssat, M.; Pépin, A.; Marty, F.; Chen, Y.; Quéré, D., Bouncing transitions on microtextured materials. Europhysics Letters 2006, 74 (2), 306.
92. Jung, Y. C.; Bhushan, B., Dynamic Effects of Bouncing Water Droplets on Superhydrophobic Surfaces. Langmuir 2008, 24 (12), 6262-6269.
93. Lee, C.; Nam, Y.; Lastakowski, H.; Hur, J. I.; Shin, S.; Biance, A.-L.; Pirat, C.; “Cj” Kim, C.-J.; Ybert, C., Two types of Cassie-to-Wenzel wetting transitions on superhydrophobic surfaces during drop impact. Soft Matter 2015, 11 (23), 4592-4599.
94. Schlaich, C.; Cuellar Camacho, L.; Yu, L.; Achazi, K.; Wei, Q.; Haag, R., Surface-Independent Hierarchical Coatings with Superamphiphobic Properties. ACS Applied Materials & Interfaces 2016, 8 (42), 29117-29127.

It will be understood that various details of the presently disclosed subject matter can be changed without departing from the scope of the subject matter disclosed herein. Furthermore, the foregoing description is for the purpose of illustration only, and not for the purpose of limitation.

What is claimed is:

1. A pesticide, comprising:
a nanocellulose scaffold, the nanocellulose scaffold including a cellulose nanocrystal (CNC) modified to include a diamine or a quaternary amine; and
a metal nanoparticle conjugated to the nanocellulose scaffold via the diamine or the quaternary amine.

2. The pesticide of claim 1, wherein the metal nanoparticle is a copper nanoparticle conjugated to the diamine of the CNC.

3. The pesticide of claim 2, wherein the CNC includes a hydroxyl group substituted with trimethylethylene diamine (TMEDA) to which the copper nanoparticle is conjugated.

4. The pesticide of claim 1, wherein the metal nanoparticle is a silver nanoparticle conjugated to the quaternary amine of the CNC.

5. The pesticide of claim 4, wherein the CNC includes a hydroxyl group substituted with a quaternary ammonium compound to which the silver nanoparticle is conjugated.

6. The pesticide of claim 1, wherein the nanocellulose scaffold includes a plurality of CNCs modified to include diamines or quaternary amines, and wherein the pesticide includes a plurality of metal nanoparticles conjugated to the nanocellulose scaffold via the diamines or the quaternary amines of the plurality of CNCs.

7. The pesticide of claim 6, wherein each CNC is bound or attracted to at least one other CNC of the plurality of CNCs.

8. A method for treating plant disease, the method comprising: administering an effective amount of pesticide to a plant in need thereof, the pesticide comprising
a nanocellulose scaffold, the nanocellulose scaffold including a cellulose nanocrystal (CNC) modified to include a diamine or quaternary amine, and
a metal nanoparticle conjugated to the nanocellulose scaffold via the diamine or the quaternary amine.

9. The method of claim 8, wherein the metal nanoparticle is a copper nanoparticle, and wherein the CNC includes a hydroxyl group substituted with trimethylethylene diamine (TMEDA) to which the copper nanoparticle is conjugated.

10. The method of claim 8, wherein the metal nanoparticle is a silver nanoparticle, and wherein the CNC includes a hydroxyl group substituted with a quaternary ammonium compound to which the silver nanoparticle is conjugated.

11. The method of claim 8, wherein the nanocellulose scaffold includes a plurality of CNCs modified to include diamines or quaternary amines, and wherein the pesticide includes a plurality of metal nanoparticles conjugated to the nanocellulose scaffold via the diamines or the quaternary amines of the plurality of CNCs.

12. The method of claim 11, wherein each CNC is bound or attracted to at least one other CNC of the plurality of CNCs.

13. The method of claim 8, wherein the disease is bacterial leaf streak disease.

14. The method of claim 8, wherein the plant is infected with Xanthomonas translucens bacteria.

15. The method of claim 8, wherein the plant is a wheat plant.

16. A method for synthesizing a pesticide, comprising:
modifying one or more cellulose nanocrystals (CNCs) to include a diamine or a quaternary amine; and
conjugating one or more metal nanoparticles to the one or more CNCs via the diamine or quaternary amine of the one or more CNCs.

17. The method of claim 16, wherein modifying the one or more CNCs includes substituting a hydroxyl group of the one or more CNCs with a tosyl group to form one or more Tos-CNCs, and substituting the tosyl group of the one or more Tos-CNCs with a diamine.

18. The method of claim 17, wherein the hydroxyl group of the one or more CNCs are substituted with the tosyl group via tosylation using pyridine and p-toluenesulfonyl chloride, and wherein the tosyl group of the one or more Tos-CNCs are substituted with trimethylethylene diamine (TMEDA).

19. The method of claim 16, wherein conjugating the one or more metal nanoparticles includes conjugating one or more copper nanoparticles to the diamine of the one or more modified CNCs.

20. The method of claim 16, wherein modifying the one or more CNCs includes substituting a hydroxyl group of the one or more CNCs with a quaternary ammonium compound by mixing the one or more CNCs with glycidyltrimethylammonium chloride (GTMAC).

21. The method of claim 20, wherein modifying the one or more CNCs further includes dispersing the one or more CNCs and NaOH in a solvent including dimethyl sulfoxide (DMSO) prior to mixing the one or more CNCs with GTMAC.

22. The method of claim 16, wherein conjugating the one or more metal nanoparticles includes conjugating one or more silver nanoparticles to the quaternary amine of the one or more modified CNCs.
